(19) United States
(12) Patent Application Publication
(10) Pub. No.: US 2025/0331088 A1
(43) Pub. Date: Oct. 23, 2025

(54) LIGHTING LINKAGE METHOD, MAIN CONTROL APPARATUS FOR LIGHTING CONTROL, AND LIGHTING CONTROL SYSTEM

(71) Applicant: COMPAL ELECTRONICS, INC., Taipei City (TW)

(72) Inventors: Hao-Che Huang, Taipei City (TW); Yao-Lin Chang, Taipei City (TW); Jui-Min Huang, Taipei City (TW); Ching-Tai Chang, Taipei City (TW)

(73) Assignee: COMPAL ELECTRONICS, INC., Taipei City (TW)

(21) Appl. No.: 19/185,273

(22) Filed: Apr. 22, 2025

Related U.S. Application Data
(60) Provisional application No. 63/637,384, filed on Apr. 23, 2024.

(51) Int. Cl. H05B 47/19; H05B 47/11; H05B 47/155; H05B 47/165; H05B 47/175

(52) U.S. Cl. CPC H05B 47/19; H05B 47/11; H05B 47/155; H05B 47/165; H05B 47/1985

(57) ABSTRACT

Provided are a lighting linkage method, a main control apparatus for lighting control, and a lighting control system. The relative positions of a reference device and one or more light emitting devices are measured via a wireless signal. The reference device and the one or more light emitting devices are connected using a communication protocol corresponding to the wireless signal, and each light emitting device includes one or more light elements. The one or more light elements of the light emitting device are controlled based on the relative positions of the reference device and the one or more light emitting devices. Thereby, a lighting linkage effect for multiple devices is achieved.

### CROSS-REFERENCE TO RELATED APPLICATION

This application claims the priority benefit of U.S. provisional application Ser. No. 63/637,384, filed on Apr. 23, 2024. The entirety of the above-mentioned patent application is hereby incorporated by reference herein and made a part of this specification.

### BACKGROUND

### Technical Field

The disclosure relates to a lighting control technology, and particularly relates to a lighting linkage method, a main control apparatus for lighting control, and a lighting control system.

### Related Art

In recent years, users of electronic devices have increasingly emphasized personalized and immersive experiences. To meet such demand, many electronic device manufacturers have begun to incorporate light emitting devices into their products (such as keyboards, mice, monitors, and computer hosts). Users may also adjust the light colors and patterns of these devices through software.

However, the existing lighting control systems have some disadvantages:
(1) Interaction between a single host and peripheral devices: Existing technology mainly focuses on lighting interaction between a single host and peripheral devices. For example, although users may control the lighting effects of the host and peripheral devices (such as mice, keyboards, and monitors), there is a lack of lighting linkage between hosts.
(2) Lack of spatial position relationship: Existing technology usually does not take into consideration the spatial position relationship between light emitting devices, which may result in lighting effects that are not natural and smooth enough.

### SUMMARY

The disclosure provides a lighting linkage method, a main control apparatus for lighting control, and a lighting control system, which realizes lighting linkage between hosts and establishes the spatial position relationship.

A main control apparatus for lighting control according to an embodiment of the disclosure includes (but is not limited to) a communication transceiver and a processor. The communication transceiver is configured to transmit or receive a signal. The processor is coupled to the communication transceiver, and configured to: obtain information about relative positions of a reference device and one or more light emitting devices via the communication transceiver. The relative positions of the reference device and the one or more light emitting devices are measured via a wireless signal. The reference device and the one or more light emitting devices are connected using a communication protocol corresponding to the wireless signal, and each light emitting device includes one or more light elements.

A lighting linkage method according to an embodiment of the disclosure includes (but is not limited to) the following. Relative positions of a reference device and one or more light emitting devices are measured via a wireless signal, in which the reference device and the one or more light emitting devices are connected using a communication protocol corresponding to the wireless signal, and each light emitting device includes one or more light elements. The one or more light elements of the one or more light emitting devices are controlled based on the relative positions of the reference device and the one or more light emitting devices.

A lighting control system according to an embodiment of the disclosure includes the above-mentioned main control apparatus and one or more light emitting devices.

Based on the above, the lighting linkage method, the main control apparatus for lighting control, and the lighting control system according to embodiments of the disclosure use a wireless signal to measure positions. Accordingly, the light elements of the light emitting devices at the corresponding positions can be controlled according to the results of position measurement, thereby linking the light elements of multiple light emitting devices.

To make the above features and advantages of the disclosure more understandable, exemplary embodiments are provided below with detailed description in conjunction with the accompanying drawings as follows.

### BRIEF DESCRIPTION OF THE DRAWINGS

FIG. 1 is a component block diagram of the lighting control system according to an embodiment of the disclosure.

FIG. 2A is a schematic diagram illustrating the relative positions of the host devices in the lighting control system according to an embodiment of the disclosure.

FIG. 2B is a schematic diagram illustrating the relative positions of the host devices and the peripheral devices in the lighting control system according to an embodiment of the disclosure.

FIG. 3 is a flowchart of the lighting linkage method according to an embodiment of the disclosure.

FIG. 4 is a flowchart of positioning according to an embodiment of the disclosure.

FIG. 5 is a flowchart of color determination according to an embodiment of the disclosure.

FIG. 6 is a schematic diagram of color distribution definition according to an embodiment of the disclosure.

FIG. 7A is a schematic diagram of the color distribution of the virtual space according to an embodiment of the disclosure.

FIG. 7B is a schematic diagram of the color distribution of the virtual space according to an embodiment of the disclosure.

FIG. 7C is a schematic diagram of the color distribution of the virtual space according to an embodiment of the disclosure.

FIG. 8 is a schematic diagram of the color sequences at multiple time points according to an embodiment of the disclosure.

FIG. 9A is a schematic diagram of the lighting effect at a time point according to an embodiment of the disclosure.

FIG. 9B is a schematic diagram of the lighting effect at another time point according to an embodiment of the disclosure.

FIG. 9C is a schematic diagram illustrating the lighting effects at multiple time points for the virtual space according to an embodiment of the disclosure.

FIG. 9D is a schematic diagram illustrating the lighting effects at multiple time points for the virtual space according to an embodiment of the disclosure.

FIG. 9E is a schematic diagram illustrating the lighting effects at multiple time points for the virtual space according to an embodiment of the disclosure.

FIG. 10 is a flowchart of the lighting linkage method for a new position according to an embodiment of the disclosure.

FIG. 11 is a schematic diagram illustrating the continued use of the virtual space according to an embodiment of the disclosure.

FIG. 12 is a schematic diagram illustrating the color distribution of the reduced virtual space according to an embodiment of the disclosure.

FIG. 13 is a schematic diagram illustrating the color distribution of the reduced virtual space according to an embodiment of the disclosure.

FIG. 14 is a schematic diagram illustrating the color distribution of the enlarged virtual space according to an embodiment of the disclosure.

FIG. 15 is a schematic diagram illustrating origin update according to an embodiment of the disclosure.

FIG. 16 is a schematic diagram illustrating origin update according to another embodiment of the disclosure.

FIG. 17 is a flowchart of the diffusion linkage method according to an embodiment of the disclosure.

FIG. 18 is a schematic diagram of color distribution definition based on the user command according to an embodiment of the disclosure.

FIG. 19 is a schematic diagram of the user command according to an embodiment of the disclosure.

FIG. 20A is a schematic diagram illustrating the color distribution of the diffusion area at the initial time point according to an embodiment of the disclosure.

FIG. 20B is a schematic diagram illustrating the color distribution of the diffusion area at another time point according to an embodiment of the disclosure.

FIG. 20C is a schematic diagram illustrating the color distribution of the diffusion area at another time point according to an embodiment of the disclosure.

FIG. 21A is a schematic diagram illustrating the color distribution of the diffusion area at another time point according to an embodiment of the disclosure.

FIG. 21B is a schematic diagram illustrating the color distribution of the diffusion area at a maximum diffusion time point according to an embodiment of the disclosure.

### DESCRIPTION OF THE EMBODIMENTS

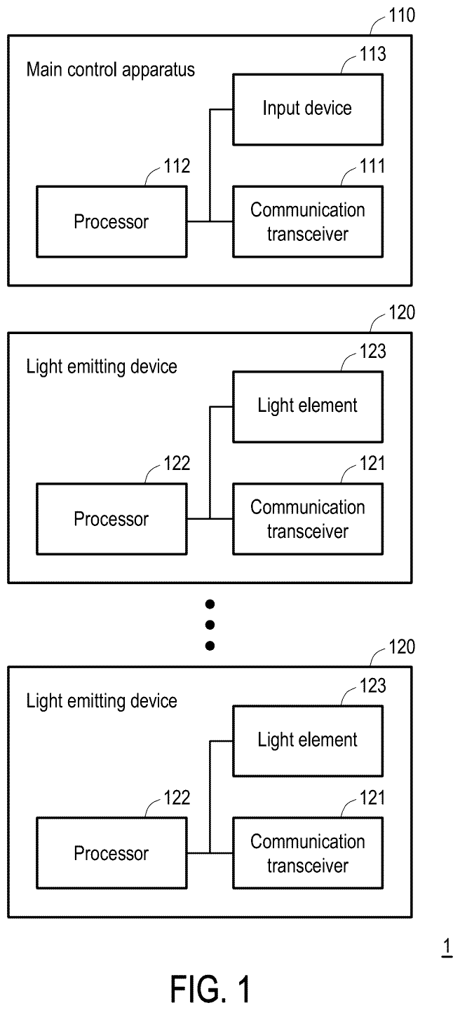

FIG. 1 is a component block diagram of a lighting control system 1 according to an embodiment of the disclosure. Referring to FIG. 1, the lighting control system 1 includes (but is not limited to) a main control apparatus 110 and one or more light emitting devices 120.

The main control apparatus 110 may be a smartphone, a tablet computer, a wearable device, a laptop computer, a desktop computer, an all-in-one PC, a server, a smart home appliance, a smart assistant device, an in-vehicle system, a conference phone, a home game console, a personal computer, an artificial intelligence personal computer (AI PC), or other electronic devices.

The main control apparatus 110 includes a communication transceiver 111, a processor 112, and an input device 113.

The communication transceiver 111 may support communication transceiver circuits/transmission interfaces such as Bluetooth, Wi-Fi, Ultra-Wideband (UWB), Radio Frequency Identification (RFID), or other wireless communication technologies. In an embodiment, the communication transceiver 111 is configured to receive a wireless signal from an external device (for example, light emitting device 120) or transmit a wireless signal to the external device (for example, light emitting device 120). In some embodiments, the communication transceiver 111 is configured to establish connection with the light emitting device 120, and accordingly transmit or receive a signal. The signal may carry various types of data and/or commands.

The processor 112 is coupled to the communication transceiver 111. The processor 112 may be a central processing unit (CPU), a graphic processing unit (GPU), a data processing unit (DPU), a visual processing unit (VPU), a tensor processing unit (TPU) or a neural-network processing unit (NPU), other programmable general-purpose or special-purpose microprocessor, a digital signal processor (DSP), a programmable controller, a field programmable gate array (FPGA), an application-specific integrated circuit (ASIC,) or other similar components or combinations of the above components. In an embodiment, the processor 112 is configured to execute all or some of the operations of the main control apparatus 110, and may load and execute one or more software modules, files and/or data stored in the memory.

The input device 113 is coupled to the processor 112. The input device 113 may be, for example, a microphone, a mouse, a keyboard, a touch panel, or a button. In an embodiment, the input device 113 is configured to receive a user command. The user command corresponds to a function, a parameter, a content, or a switch specified by a user operation (for example, speaking, pressing, sliding, clicking, or touching operation).

The light emitting device 120 may be a host device such as a smartphone, a tablet computer, a wearable device, a laptop computer, a desktop computer, a server, a smart home appliance, a smart assistant device, an in-vehicle system, a conference phone, a home game console, a personal computer, an artificial intelligence personal computer (AI PC), or other electronic devices. The host device has computing and decision-making functions. In addition, the host device may be connected to other host devices and/or the main control apparatus 110 to transmit or receive a signal. Alternatively, the light emitting device 120 may be an accessory/subordinate/peripheral device (hereinafter collectively referred to as accessory device) such as a mouse, a mouse pad, a display device, a keyboard, a game controller, a case, a speaker, a microphone, a smart light fixture, a headphone, a stylus, or other electronic devices. The accessory device may be connected to the corresponding host device to transmit or receive a signal.

The light emitting device 120 includes a communication transceiver 121, a processor 122, and one or more light elements 123.

The embodiments and functions of the communication transceiver 121 and the processor 122 may refer to the above description for the communication transceiver 111 and the processor 122, which will not be repeated here.

In an embodiment, the communication transceiver 121 is configured to be connected to the main control apparatus 110 and/or other light emitting devices 120, and transmit or receive a signal accordingly. The signal may carry various types of data and/or commands.

The processor 122 is coupled to the communication transceiver 121 and the light element 123. In an embodiment, the processor 122 is configured to execute all or some of the operations of the light emitting device 120, and may load and execute one or more software modules, files and/or data stored in the memory. In an embodiment, the processor 122 runs lighting effect software.

The light element 123 may be a light strip, an illuminated keycap, an illuminated scroll wheel, an illuminated logo, an illuminated fan, a screen backlight, an illuminated ear cup, an LED backlight, an RGB light strip, or other light elements. In an embodiment, the light element 123 may emit light with a specified color, brightness and/or color temperature, and/or flash according to a specified emission frequency.

In some embodiments, a certain light emitting device 120 may serve as the main control apparatus 110.

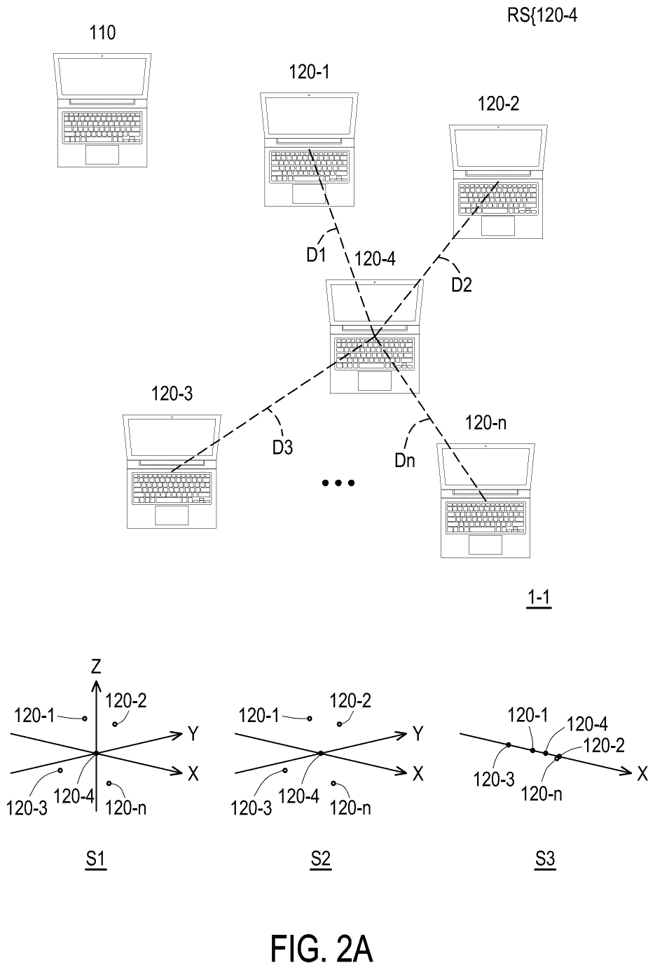

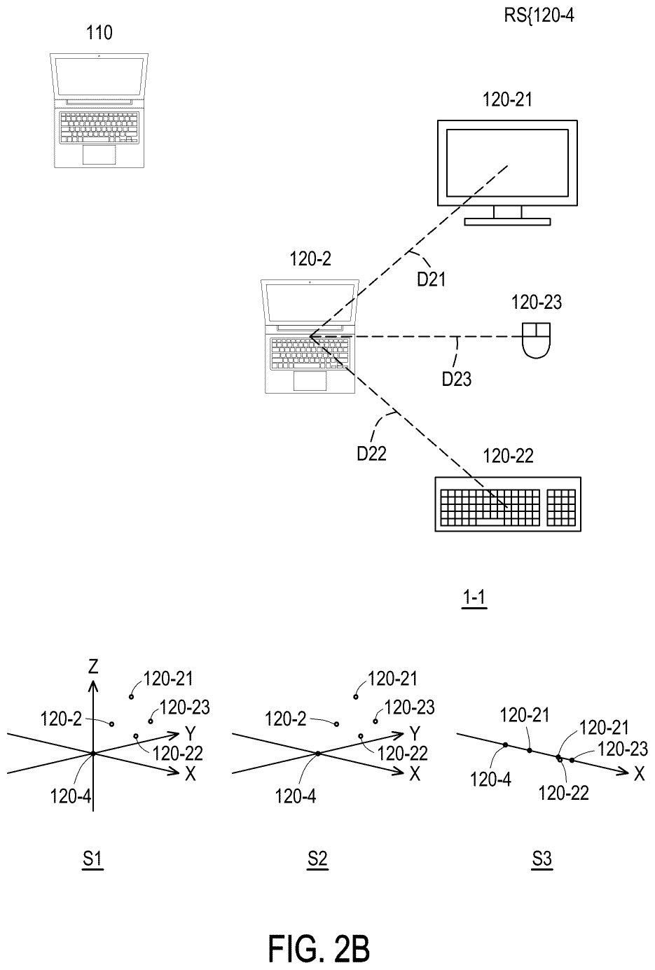

For example, FIG. 2A is a schematic diagram illustrating the relative positions of the host devices in a lighting control system 1-1 according to an embodiment of the disclosure. Referring to FIG. 2A, the lighting control system 1-1 includes a main control apparatus 110 (in some embodiments, also serving as a light emitting device 120) and light emitting devices 120-1 to 120-n (that is, host devices, using a laptop computer as an example, where n is a positive integer). In this embodiment, a reference device RS is the light emitting device 120-4. The reference device RS is used as a center for positioning, and the positioning method will be described in detail in subsequent embodiments. In some embodiments, the reference device RS may also be the main control apparatus 110.

For another example, FIG. 2B is a schematic diagram illustrating the relative positions of the host devices and the peripheral devices in the lighting control system according to an embodiment of the disclosure. Referring to FIG. 2B, the lighting control system 1-1 includes a main control apparatus 110 (in some embodiments, also serving as a light emitting device 120), a light emitting device 120-2 (using a laptop computer as an example), a light emitting device 120-21 (that is, peripheral device, using a display device as an example), a light emitting device 120-22 (that is, peripheral device, using a keyboard as an example), and a light emitting device 120-23 (that is, peripheral device, using a mouse as an example).

It should be noted that the number and types of the main control apparatus 110 and the light emitting devices 120 shown in FIG. 2A and FIG. 2B are only used for exemplary illustration, and may be adjusted according to actual requirements in other application scenarios, and the embodiments of the disclosure are not limited thereto.

In the following, the method described in the embodiments of the disclosure will be illustrated in conjunction with the devices, components, and modules in the lighting control systems 1 and 1-1. Each process of this method may be adjusted according to the situation of implementation, and is not limited thereto.

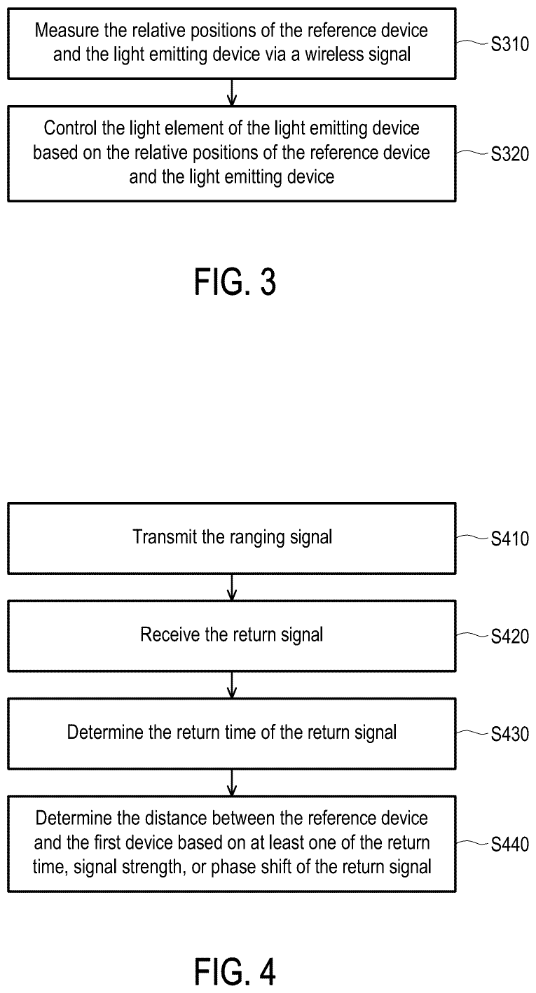

FIG. 3 is a flowchart of a lighting linkage method according to an embodiment of the disclosure Referring to FIG. 3, the processor 122 of the reference device RS measures the relative positions of the reference device RS and one or more light emitting devices 120 via a wireless signal (step S310). Specifically, the reference device RS and one or more light emitting devices 120 are connected using a communication protocol corresponding to the wireless signal. The communication transceiver 121 of the reference device RS and the communication transceiver 121 of the light emitting device 120 are connected using the same or compatible communication protocols (for example, Bluetooth, Wi-Fi, or Ultra-wideband), allowing wireless signal transmission between the devices. In addition, the reference device RS and the main control apparatus 110 are connected using a communication protocol corresponding to the wireless signal. The communication transceiver 121 of the reference device RS and the communication transceiver 111 of the main control apparatus 110 are connected using the same or compatible communication protocols (for example, Bluetooth, Wi-Fi, or Ultra-wideband), allowing wireless signal transmission between the devices.

It is worth noting that the wireless signal may be used to measure the relative positions of two devices, that is, positioning, for example, the distance between two devices, and/or the angle/orientation/direction of one device relative to another device.

FIG. 4 is a flowchart of positioning according to an embodiment of the disclosure. Referring to FIG. 4, the processor 122 of the reference device RS transmits a ranging signal via the communication transceiver 121 (step S410). The ranging signal is used to indicate feedback of a return signal or a ranging mode. The processor 122 of the light emitting device 120 receives the ranging signal via the communication transceiver 121, enters the ranging mode, and transmits the return signal. This return signal is used to feedback the ranging signal. The processor 122 of the reference device RS receives the return signal via the communication transceiver 121 (step S420). This return signal may include identification information of a sender to distinguish the return signals from multiple light emitting devices 120.

The processor 112 may determine a return time of the return signal (step S430). After the ranging signal is sent, the processor 112 starts timing until receiving the corresponding return signal and stops timing. This timing period may be called a round-trip time of the wireless signal. The processor 112 may determine the return time based on the round-trip time of the wireless signal (including the transmission time of the ranging signal and the return time of the return signal). For example, a value obtained by dividing the round-trip time by two (possibly minus some processing time) may be used as the return time.

One or more light emitting devices 120 include a first device. Taking FIG. 2A as an example, the first device is the light emitting device 120-1. Next, the processor 112 determines the distance between the reference device RS and the first device (for example, the light emitting device 120-1) based on at least one of the return time, the signal strength, or the phase shift corresponding to the light emitting device 120-1 (step S440). In an embodiment, the transmission time of the wireless signal is related to the distance between two devices. When the distance between two devices increases, the transmission time increases. When the distance between two devices decreases, the transmission time decreases. Therefore, the wireless signal may be used for ranging. The transmission of a wireless signal usually travels at the speed of light. Although the wireless signal may be affected by the environment (for example, air, water, or buildings), the speed is still close to the speed of light. The processor 112 may use a value obtained by multiplying the return time by the speed of light (or a value close to the speed of light) as the distance between the main control apparatus 110 and the light emitting device 120-1.

In another embodiment, the reference device RS may determine the distance from the first device based on the signal strength of the return signal. Signal strength is, for example, a received signal strength indicator (RSSI), a reference signal received power, or the like. It is worth noting that the power of the wireless signal attenuates as the distance increases. This attenuation typically follows the inverse square law. For example, the relationship between signal strength and distance is based on the free space path model. When the distance doubles, the power weakens to one-fourth of the original value; when the distance increases threefold, the power weakens to one-ninth of the original value, and so on. Therefore, the received power of the return signal may be used for ranging.

In another embodiment, the reference device RS may determine the distance from the first device based on the phase shift of the return signal. Channel sounding uses the phase shift of a signal to measure the distance of signal propagation. When the return signal is transmitted from the first device to the reference device RS, the phase of the return signal changes with the propagation distance. The reference device RS measures this phase shift and calculates the distance based on the phase shift of the return signal and the signal wavelength. For example,

$$R = {N}_{eff} {λ}_{eff} + \frac{{ϕ}_{eff} {λ}_{eff}}{2 π} ,$$

where R is the distance between the reference device RS and the first device, N_{eff} is a constant, λ_{eff} is the virtual wavelength generated based on the signal wavelengths of return signals of two different frequencies, and ϕ_{eff} is the composite phase shift of two return signals (ϕ_{eff}=|ϕ₁−ϕ₂|, where ϕ₁ is the signal wavelength of one frequency, and ϕ₂ is the signal wavelength of another frequency).

Similarly, in FIG. 2A, the reference device RS may perform ranging on the light emitting devices 120-2 to 120-n (excluding the light emitting device 120-4) via wireless signals, and accordingly determine the relative positions of these devices. Alternatively, in FIG. 2B, the light emitting device 120-2 (serving as the reference device RS) performs ranging on the light emitting devices 120-21 to 120-23 via wireless signals, and accordingly determine the relative positions of these devices.

In an embodiment, the processor 122 of the reference device RS may determine the angle of the first device relative to the reference device RS based on the angle of arrival of the return signal. For example, the communication transceiver 121 may include an antenna array (composed of multiple antennas). The antenna array supporting Angle of Arrival (AoA) may measure the phase difference between the ranging signal and the return signal, thereby calculating the angle from which the return signal originates. Alternatively, based on the known position of the transmitting antenna and the propagation path of the ranging signal, the Angle of Departure (AoD) may be derived through geometric calculations.

In another embodiment, the ranging signal may also be transmitted from other light emitting devices 120 to the reference device RS, and the reference device RS may transmit the return signal to other light emitting devices.

In an embodiment, the processor 112 of the main control apparatus 110 may obtain information about the relative positions of the reference device RS and one or more light emitting devices 120 (including the distance between the reference device RS and the light emitting device 120 and/or the angle of the light emitting device 120 relative to the reference device RS) via the communication transceiver 111. In an embodiment, the angle-related information includes horizontal angle information and vertical angle information. The reference device RS and/or other light emitting devices 120 may transmit information about the relative positions of the reference device RS and one or more light emitting devices 120.

In an embodiment, the processor 112 of the main control apparatus 110 or the processor 122 of the reference device RS may convert the information about the relative positions of the reference device RS and one or more light emitting devices 120 into lighting effect coordinates in a virtual space. Taking FIG. 2A as an example, the virtual space S1 is a three-dimensional space. The lighting effect coordinates (X1ᵢⱼ, Y1ᵢⱼ,Z1ᵢⱼ) are:

$$X {1}_{ij} = {R}_{ij} * cos ( {φ}_{ij} ) * cos ( {θ}_{ij} ) \qquad ( 1 )$$

$$Y {1}_{ij} = {R}_{ij} * cos ( {φ}_{ij} ) * sin ( {θ}_{ij} ) \qquad ( 2 )$$

$$Z {1}_{ij} = {R}_{ij} * sin ( {φ}_{ij} ) , \qquad ( 3 )$$

where i is the number of the reference device RS (i is 4 in FIG. 2A), j is the number of other light emitting devices 120 (j is 1, 2, 3, or n in FIG. 2A), X1ᵢⱼ is the coordinate of the light emitting device 120 numbered j on the X-axis in the virtual space S1, Y1ᵢⱼ is the coordinate of the light emitting device 120 numbered j on the Y-axis in the virtual space S1, Z1ᵢⱼ is the coordinate of the light emitting device 120 numbered j on the Z-axis in the virtual space S1, Rᵢⱼ is the distance between the light emitting device 120 numbered j and the reference device RS, φᵢⱼ is the vertical angle of the light emitting device 120 numbered j relative to the reference device RS numbered i, and θᵢⱼ is the horizontal angle of the light emitting device 120 numbered j relative to the reference device RS numbered i.

Taking FIG. 2B as an example, the virtual space S1 is a three-dimensional space. The lighting effect coordinates (X1ⱼₘ, Y1ⱼₘ,Z1ⱼₘ) are:

$$X {1}_{jm} = {R}_{jm} * cos ( {φ}_{jm} ) * cos ( {θ}_{jm} ) \qquad ( 4 )$$

$$Y {1}_{jm} = {R}_{jm} * {cos ( {φ}_{jm} )}^{*} sin ( {θ}_{jm} ) \qquad ( 5 )$$

$$Z {1}_{jm} = {R}_{jm} * sin ( {φ}_{jm} ) , \qquad ( 6 )$$

where j is the number of the reference device RS (i is 2 in FIG. 2B), m is the number of other light emitting devices 120 (m is 21, 22, or 23 in FIG. 2B), X1ⱼₘ is the coordinate of the light emitting device 120 numbered m on the X-axis in the virtual space S1, Y1ⱼₘ is the coordinate of the light emitting device 120 numbered m on the Y-axis in the virtual space S1, Z1ⱼₘ is the coordinate of the light emitting device 120 numbered m on the Z-axis in the virtual space S1, Rⱼₘ is the distance between the light emitting device 120 numbered m and the reference device RS, φⱼₘ is the vertical angle of the light emitting device 120 numbered m relative to the reference device RS numbered j, and θⱼₘ is the horizontal angle of the light emitting device 120 numbered m relative to the reference device RS numbered j. If the coordinate system is centered at the light emitting device 120-4, the processor 112 of the main control apparatus 110 or the processor 122 of the reference device RS may correct the lighting effect coordinates (X1ⱼₘ, Y1ⱼₘ,Z1ⱼₘ) to lighting effect coordinates (X1ᵢⱼₘ, Y1ᵢⱼₘ, 1Zᵢⱼₘ):

$$X {1}_{ijm} = X {1}_{ij} + X {1}_{jm} \qquad ( 7 )$$

$$Y {1}_{ijm} = Y {1}_{ij} + Y {1}_{jm} \qquad ( 8 )$$

$$Z {1}_{ijm} = Z {1}_{ij} + Z {1}_{jm} , \qquad ( 9 )$$

where X1ᵢⱼₘ is the coordinate of the light emitting device 120 numbered m on the X-axis in the virtual space S1 centered at the reference device RS numbered i, Y1ᵢⱼₘ is the coordinate of the light emitting device 120 numbered m on the Y-axis in the virtual space S1 centered at the reference device RS numbered i, and Z1ᵢⱼₘ is the coordinate of the light emitting device 120 numbered m on the Z-axis in the virtual space S1 centered at the reference device RS numbered i.

Taking FIG. 2A as an example, the virtual space S2 is a two-dimensional space. The lighting effect coordinates (X2ᵢⱼ, Y2ᵢⱼ) are:

$$X {2}_{ij} = {R}_{ij} * cos ( {θ}_{ij} ) \qquad ( 10 )$$

$$Y {2}_{ij} = {R}_{ij} * sin ( {θ}_{ij} ) , \qquad ( 11 )$$

where X2ᵢⱼ is the coordinate of the light emitting device 120 numbered j on the X-axis in the virtual space S2, and Y2ᵢⱼ is the coordinate of the light emitting device 120 numbered j on the Y-axis in the virtual space S2.

Taking FIG. 2B as an example, the virtual space S2 is a two-dimensional space. The lighting effect coordinates (X2ⱼₘ, Y2ⱼₘ) are:

$$X {2}_{jm} = {R}_{jm} * cos ( {θ}_{jm} ) \qquad ( 12 )$$

$$Y {2}_{jm} = {R}_{jm} * sin ( {θ}_{jm} ) , \qquad ( 13 )$$

where X2ⱼₘ is the coordinate of the light emitting device 120 numbered m on the X-axis in the virtual space S2, and Y2ⱼₘ is the coordinate of the light emitting device 120 numbered m on the Y-axis in the virtual space S2.

If the coordinate system is centered at the light emitting device 120-4, the processor 112 of the main control apparatus 110 or the processor 122 of the reference device RS may correct the lighting effect coordinates (X2ⱼₘ, Y2ⱼₘ) to lighting effect coordinates (X2ᵢⱼₘ, Y2ᵢⱼₘ):

$$X {2}_{ijm} = X {2}_{ij} + X {2}_{jm} \qquad ( 14 )$$

$$Y {2}_{ijm} = Y {2}_{ij} + Y {2}_{jm} , \qquad ( 15 )$$

where X2ᵢⱼₘ is the coordinate of the light emitting device 120 numbered m on the X-axis in the virtual space S2 centered at the reference device RS numbered i, and Y2ᵢⱼₘ is the coordinate of the light emitting device 120 numbered m on the Y-axis in the virtual space S1 centered at the reference device RS numbered 2.

Taking FIG. 2A as an example, the virtual space S1 is a one-dimensional space. The lighting effect coordinate (X3ᵢⱼ) is:

$$X {3}_{ij} = {R}_{ij} , \qquad ( 16 )$$

where X3ᵢⱼ is the coordinate of the light emitting device 120 numbered j on the X-axis in the virtual space S3.

Taking FIG. 2B as an example, the virtual space S3 is a one-dimensional space. The lighting effect coordinate (X3ⱼₘ, Y3ⱼₘ) is:

$$X {2}_{jm} = {R}_{jm} , \qquad ( 17 )$$

where X3ⱼₘ is the coordinate of the light emitting device 120 numbered m on the X-axis in the virtual space S3.

If the coordinate system is centered at the light emitting device 120-4, the processor 112 of the main control apparatus 110 or the processor 122 of the reference device RS may correct the lighting effect coordinate (X3ⱼₘ) to the lighting effect coordinate (X3ᵢⱼₘ):

$$X {3}_{ijm} = X {3}_{ij} + X {3}_{jm} , \qquad ( 18 )$$

where X3ᵢⱼₘ is the coordinate of the light emitting device 120 numbered m on the X-axis in the virtual space S3 centered at the reference device RS numbered i.

In an embodiment, the processor 112 of the main control apparatus 110 may transmit a positioning command to the reference device RS and/or other light emitting devices 120 via the communication transceiver 111, to trigger the transmission of a ranging signal and/or a return signal. That is, the positioning command is used to trigger a wireless communication positioning function.

In an embodiment, the main control apparatus 110 may find the light emitting device 120 that is separated by the farthest distance. Taking FIG. 2A as an example, the main control apparatus 110 performs ranging on the light emitting devices 120-1 to 120-n respectively, and obtains the distances D1, D2, D3 to Dn (n is a positive integer) between the main control apparatus 110 and the light emitting devices 120-1 to 120-n respectively. Then, the main control apparatus 110 compares the distances D1 to Dn, and finds the distance D3 with the maximum value. That is to say, compared to the light emitting devices 120-1, 120-2, 120-4 to 120-n, the distance between light emitting device 120-3 and the reference device RS is the maximum distance.

Positioning using wireless signals may simplify the steps required to define device positions in applications, and reduce positioning time. However, there are many other positioning methods based on wireless signals, and users may make adjustment according to actual requirements.

The processor 112 controls the light element 123 of the light emitting device 120 based on the relative positions of the reference device RS and the light emitting device 120 (step S320). Specifically, the distance and/or angle obtained from positioning the light emitting device 120 may be used to understand the relative positions between the light emitting devices 120. Understanding the relative positions of the reference device RS and the light emitting devices 120 helps achieve linkage or series connection between the light colors of these light emitting devices 120. In other words, the embodiments of the disclosure may provide consistent or linked light colors for the entirety of the light emitting devices 120.

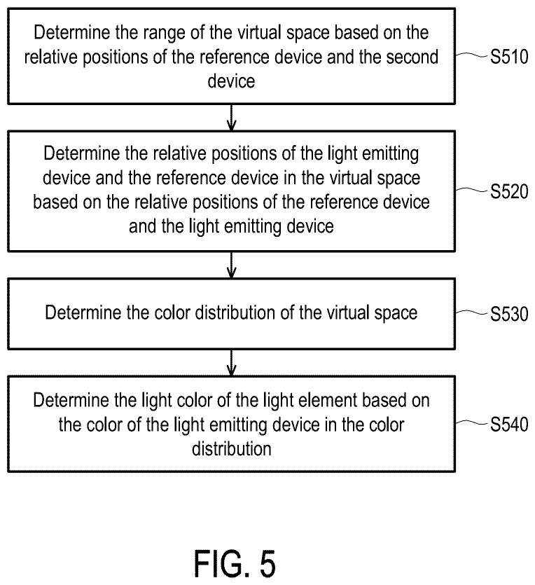

FIG. 5 is a flowchart of color determination according to an embodiment of the disclosure. Referring to FIG. 5, one or more light emitting devices 120 include a second device. The second device is separated by the farthest distance from the reference device RS. Taking FIG. 2A as an example, the second device is the light emitting device 120-3. The processor 112 may determine the range of the virtual space based on the distance between the reference device RS and the second device (step S510). Specifically, the virtual space is a virtual space established by the lighting control software executed by the main control apparatus 110. The virtual space may be used to set or present the relative positions between the devices and the light colors of the light elements 120 thereof. In an embodiment, each position in the virtual space corresponds to a color. In another embodiment, each position in the virtual space corresponds to a color, brightness and/or color temperature.

In an embodiment, the reference device RS is located at the center of the virtual space. Taking FIG. 2A as an example, the light emitting device 120-4 serving as the reference device RS is located at the center of the virtual spaces S1 to S2 respectively. Additionally, the processor 112 may define the distance between the reference device RS and the second device (that is, the maximum distance) as the maximum distance between the center and the outer contour of the virtual space.

For example, the virtual space may be a one-dimensional line, a two-dimensional circle, a three-dimensional cylinder, a three-dimensional sphere, or other geometric or non-geometric shaped space. When the virtual space is a two-dimensional circle, the distance between the reference device RS and the second device is the radius of this two-dimensional circle, and the coordinates (0, 0) of the reference device RS may serve as the center of this two-dimensional circle. When the virtual space is a three-dimensional cylinder, the distance between the reference device RS and the second device is the radius of this three-dimensional cylinder, and the coordinates (0, 0) of the reference device RS may serve as the axis of this three-dimensional cylinder. When the virtual space is a three-dimensional sphere, the distance between the reference device RS and the second device is the radius of this three-dimensional sphere, and the coordinates (0, 0) of the reference device RS may serve as the center of this three-dimensional sphere. When the virtual space has other shapes, the reference device RS is the geometric center or center of gravity of this virtual space.

In another embodiment, the reference device RS is located at the starting point of the virtual space. Taking FIG. 2A as an example, the light emitting device 120-4 serving as the reference device RS is located at the starting point of the virtual space S3.

The processor 112 may determine the relative positions of the light emitting device 120 and the reference device RS in the virtual space based on the relative positions of the reference device RS and the light emitting device 120 (step S520). Specifically, the processor 112 may map the positions of the light emitting device 120 and the reference device RS in the real space to the same positions in the virtual space respectively, based on the distance and/or angle obtained through positioning using the reference device RS as the center (for multi-dimensional space) or starting point (for one-dimensional space). Taking FIG. 2A as an example, the distance D1 between the light emitting device 120-1 and the reference device RS is the same as the distance in the virtual space, or the distance may be proportionally reduced or enlarged according to requirements. The processor 112 may convert the information about the relative positions of the reference device RS and one or more light emitting devices 120 obtained from positioning into lighting effect coordinates in the virtual space. As mentioned above, equations (1) to (9) are used for a three-dimensional space, equations (10) to (15) are used for a two-dimensional space, or equations (16) to (18) are used for a one-dimensional space, which will not be repeated here.

The processor 112 may determine the color distribution of the virtual space (step S530). As described above, each position in the virtual space corresponds to a color. The color distribution is the distribution of the color at each position in the virtual space.

In an embodiment, the processor 112 may set a color value upper limit and a color value lower limit of the color distribution. Taking red (R)-green (G)-blue (B) as an example, the RGB value of the color value upper limit is (Rₘₐₓ, Gₘₐₓ, Bₘₐₓ), and the RGB value of the color value lower limit is (R₀, G₀, B₀).

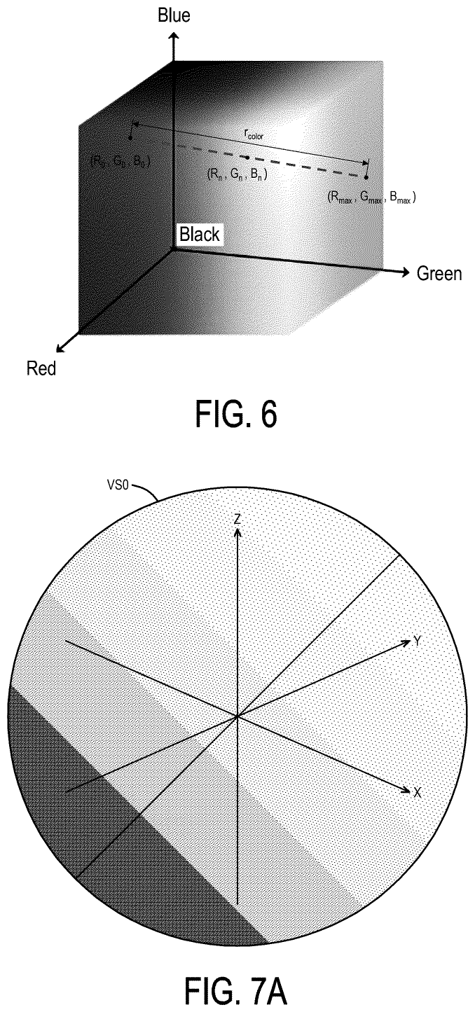

For example, FIG. 6 is a schematic diagram illustrating color distribution definition according to an embodiment of the disclosure. Referring to FIG. 6, in the RGB color space, the RGB value (R₀, G₀, B₀) of the color value lower limit corresponds to, for example, pink, and the RGB value (Rₘₐₓ, Gₘₐₓ, Bₘₐₓ) of the color value upper limit corresponds to, for example, bright green.

The processor 112 may determine the color radius r_{color} of the color distribution of the virtual space based on the color value upper limit and the color value lower limit. For example,

$${r}_{color} = \sqrt{{( {R}_{0} - {R}_{max} )}^{2} + {( {G}_{0} - {G}_{max} )}^{2} + {( {B}_{0} - {B}_{max} )}^{2}} . \qquad ( 19 )$$

In an embodiment, the processor 112 may receive one or more user commands via the input device 113. The user command is used to set the color value upper limit and the color value lower limit. In another embodiment, the user command is further used to define the center of the virtual space.

Referring to FIG. 5, the processor 112 may determine the color of the light emitting device 120 in the color distribution based on the relative position of the light emitting device 120 in the virtual space (step S540). Then, the processor 112 may determine the light color of one or more light elements 123 based on the color of the light emitting device 120 in the color distribution (step S550). Specifically, each light emitting device 120 is located at a specific position in the virtual space, and the color distribution of the virtual space has been defined. Therefore, the processor 112 may know the color at the position where the light emitting device 120 is located in the color distribution.

In an embodiment, the processor 112 may correspond the color of the second device that is farthest from the center to the color value upper limit of the color distribution, and correspond the color of the reference device RS (or other light emitting device 120) located at the center or starting point to the color value lower limit of the color distribution. Taking FIG. 6 as an example, the color value of the color of the second device is the same as the RGB value (Rₘₐₓ, Gₘₐₓ, Bₘₐₓ) of the color value upper limit, and the color value of the color of the reference device RS is the same as the RGB value (R₀, G₀, B₀) of the color value lower limit.

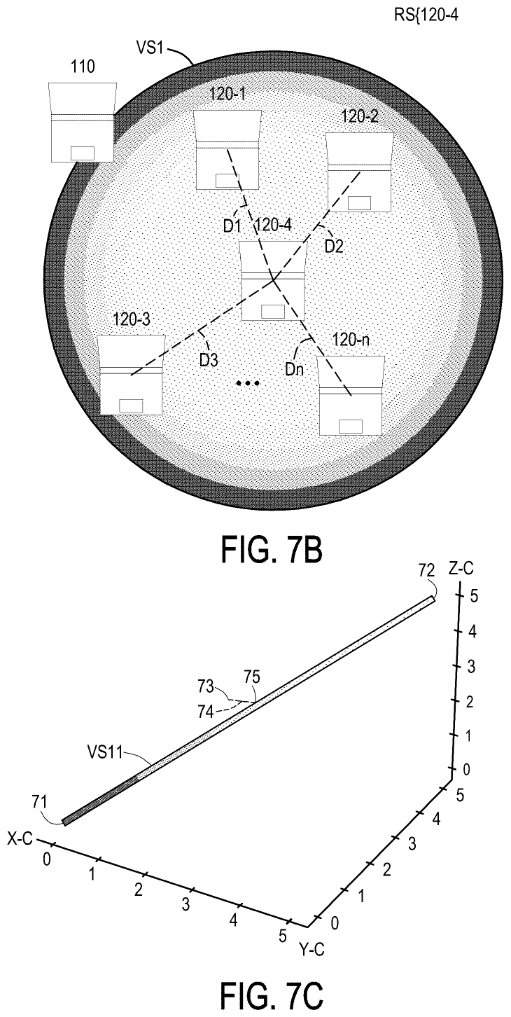

In an embodiment, the processor 112 may determine a conversion function of the color distribution. In this conversion function, the color value of the color distribution gradually varies from the color value of a first point in the virtual space to the color value of a second point in the virtual space. The first point is a point on the boundary of the virtual space, the second point is another point on the boundary of the virtual space, and the straight line connecting the first point and the second point passes through the center of the virtual space. For example, FIG. 7A is a schematic diagram illustrating the color distribution of the virtual space VS0 according to an embodiment of the disclosure. Referring to FIG. 7A, the virtual space VS0 is a three-dimensional sphere. The first point is located at the upper right corner of the sphere surface from the viewing angle presented in FIG. 7A, and the second point is located at the lower left corner of the sphere surface. Therefore, the gradient effect of the color distribution gradually changes in color from the upper right corner of the sphere surface to the lower left corner of the sphere surface from the viewing angle presented in FIG. 7A.

It is assumed that the coordinates of the first point on the sphere surface of the sphere (xₛ, yₛ, zₛ)=(rₘₐₓ sin ϕ cos θ, Iₘₐₓ sin ϕ sin θ, rₘₐₓ cos ϕ) correspond to the RGB value (rₓₛ, g_{ys}, b_{zs}). Imax is the radius of the sphere, ϕ is the vertical angle relative to the center, and θ is the horizontal angle relative to the center. Furthermore, it is assumed that the coordinates of the second point on the sphere surface of the sphere (x′ₛ, y′ₛ, z′ₛ)=(−xₛ, −yₛ, −zₛ) correspond to the RGB value (r_{x′s}, g_{y′s}, b_{z′s}). The relative distance proportion of a third point in the virtual space VS0 (with coordinates (x,y,z), assuming it is the position of a certain light emitting device 120) to the first point on the sphere surface is

$${ω}_{s} = \frac{{r}_{max} - d}{{r}_{max}} ,$$

and d is the distance from the third point to the first point. The relative distance proportion of the third point in the virtual space VS0 (with coordinates (x,y,z)) to the second point on the sphere surface is

$${ω}_{s}^{′} = \frac{{r}_{max} - {d}^{′}}{{r}_{max}} ,$$

and d′ is the distance from the third point to the second point. Therefore, the processor 112 may obtain the RGB value (r, g, b) corresponding to the third point by interpolating the color values corresponding to the first point and the second point:

$$r = {ω}_{s} {r}_{x s} + {ω}_{s}^{′} {r}_{{x}^{′} s} \qquad ( 20 )$$

$$g = {ω}_{s} {g}_{y s} + {ω}_{s}^{′} {g}_{{y}^{′} s} \qquad ( 21 )$$

$$b = {ω}_{s} {b}_{z s} + {ω}_{s}^{′} {b}_{{z}^{′} s} . \qquad ( 22 )$$

If the virtual space is a two-dimensional circle, the coordinates of the first point on the boundary of the circle (x_{c}, y_{c})=(rₘₐₓ cos θ, rₘₐₓ sin θ) correspond to the RGB value (r_{c}, g_{c}, b_{c}). rₘₐₓ is the radius of the circle, and θ is the horizontal angle relative to the center. Furthermore, it is assumed that the coordinates of the second point on the boundary of the circle (x′_{c}, y′_{c})=(−x_{c}, −y_{c}) correspond to the RGB value (r′_{c}, g′_{c}, b′_{c}). The relative distance proportion of a third point in the virtual space (with coordinates (x,y), assuming it is the position of a certain light emitting device 120) to the first point is

$${ω}_{c} = \frac{d}{{r}_{max}} ,$$

and d is the distance from the third point to the first point. The relative distance proportion of the third point in the virtual space (with coordinates (x,y)) to the second point is

$${ω}_{c}^{′} = \frac{{d}^{′}}{{r}_{max}} ,$$

and d′ is the distance from the third point to the second point. Therefore, the processor 112 may obtain the color value (r, g, b) corresponding to the third point by interpolating the color values corresponding to the first point and the second point:

$$r = {ω}_{c} {r}_{c} + {ω}_{c}^{′} {r}_{c}^{′} \qquad ( 23 )$$

$$g = {ω}_{c} {g}_{c} + {ω}_{c}^{′} {g}_{c}^{′} \qquad ( 24 )$$

$$b = {ω}_{c} {b}_{c} + {ω}_{c}^{′} {b}_{c}^{′} . \qquad ( 25 )$$

In an embodiment, the processor 112 may determine a conversion function for the color distribution based on the color value upper limit and the color value lower limit. In this conversion function, the color value of the color distribution gradually varies from the color value lower limit at the center to the color value upper limit. For example,

$${R}_{n} = {R}_{0} + \frac{{Y}_{n} \times {r}_{color}}{{Y}_{max}} \qquad ( 26 )$$

$${G}_{n} = {G}_{0} + \frac{{Y}_{n} \times {r}_{color}}{{Y}_{max}} \qquad ( 27 )$$

$${B}_{n} = {B}_{0} + \frac{{Y}_{n} \times {r}_{color}}{{Y}_{max}} , \qquad ( 28 )$$

Rₙ is the red value corresponding to a position (for example, the position of the light emitting device 120-n in FIG. 2A, where n is a positive integer) at a distance Yₙ from the center (for example, the position of the reference device RS) in the virtual space, Gₙ is the green value corresponding to a position at a distance Yₙ from the center (for example, the position of the reference device RS) in the virtual space, Bₙ is the blue value corresponding to a position at a distance Yₙ from the center (for example, the position of the reference device RS) in the virtual space, and the distance Yₘₐₓ is the maximum distance mentioned above (that is, the farthest distance from the center). Therefore, the processor 112 may obtain the color of this light emitting device 120 in the color distribution by inputting the information about the relative positions of the reference device RS and the light emitting device 120 into the conversion function. Taking FIG. 2A as an example, the processor 112 can obtain the colors corresponding to the light emitting devices 120-1 to 120-n by inputting the values of distances D1 to D into the conversion function respectively.

For example, FIG. 7B is a schematic diagram of the color distribution of the virtual space VS1 according to an embodiment of the disclosure. Referring to FIG. 6 and FIG. 7B, the virtual space VS1 is a two-dimensional circle. The color of the light element 123 of the reference device RS (as the light emitting device 120) is the RGB value (R₀, G₀, B₀) of the color value lower limit, and the color of the light emitting device 120-3 is the RGB value (Rₘₐₓ, Gₘₐₓ, Bₘₐₓ) of the upper limit of color value. As for the colors of the light elements 123 of other light emitting devices 120, the corresponding RGB values can be obtained by substituting the distances D1 to Dn into equations (26) to (28) respectively.

In another embodiment, in the conversion function, the color value of the color distribution gradually varies from the color value of a first point in the virtual space to the color value of a second point in the virtual space. The first point is the starting point in the virtual space, and the second point is the ending point in the virtual space. The positions of the two points may be based on a user command or may be preset. For example, FIG. 7C is a schematic diagram of the color distribution of the virtual space VS11 according to an embodiment of the disclosure. Referring to FIG. 7C, the virtual space VS1 is a one-dimensional line segment. It is assumed that the RGB value corresponding to the starting point 71 (that is, the first point) of the line segment is (R₀, G₀, B₀), and the RGB value corresponding to the ending point 72 (that is, the first point) of the line segment is (Re, Ge, Be). Then, the third point 73 in the space (with coordinates (X1ⱼₘ, Y1ⱼₘ,Z1ⱼₘ), assuming it is the position of a certain light emitting device 120) is projected along the projection line 74 onto the virtual space VS11 (that is, the line segment from the starting point 71 to the ending point 72), which forms the projection point 75. The RGB value (Rᵢⱼₘ, Gᵢⱼₘ, Bᵢⱼₘ) corresponding to the projection point 75 is:

$${R}_{ijm} = {R}_{0} + \frac{- {x}_{ijm}}{{x}_{e}} ( {R}_{e} - {R}_{0} ) \qquad ( 29 )$$

$${G}_{ijm} = {G}_{0} + \frac{- {x}_{ijm}}{{x}_{e}} ( {R}_{e} - {R}_{0} ) \qquad ( 30 )$$

$${B}_{ijm} = {B}_{0} + \frac{- {x}_{ijm}}{{x}_{e}} ( {R}_{e} - {R}_{0} ) . \qquad ( 31 )$$

In an embodiment, one or more light emitting devices 120 include a third device. Taking FIG. 7 as an example, the third device is the light emitting device 120-1, 120-2, 120-3, or 120-n. The processor 112 may transmit a lighting indication signal to the third device via the communication transceiver 111. This lighting indication signal includes the color value of the color corresponding to the third device. That is to say, the light emitting device 120 may control the light element 123 thereof to emit light of a specified color based on the lighting indication signal. The light of the specified color mentioned above is from the color at the corresponding position on the color distribution. In addition, the lighting indication signal also includes identification information of the light emitting device 120. The light emitting device 120 may thereby determine whether the lighting indication signal belongs to itself based on this identification information.

In an embodiment, the processor 112 may control the light element 123 of the main control apparatus 110 (which may be referred to as the second light element for the main control apparatus 110, and has the same or similar or corresponding implementation aspects and/or functions as the light element 123) (that is, the main control apparatus 110 serving as a light emitting device 120) based on the relative positions of the reference device RS and the main control apparatus 110. Similarly, by understanding the relative positions of the reference device RS and the main control apparatus 110, the light color of the main control apparatus 110 may be further controlled, and linked or connected in series with the light emission of other light emitting devices 120.

In an embodiment, the lighting control system 1 includes multiple light emitting devices 120. The processor 112 may determine a first color sequence of these light emitting devices 120 at a first time point. This first color sequence is obtained by arranging the color values corresponding to these light emitting devices 120 according to the distances of the multiple light emitting devices 120 relative to the reference device RS at the first time point.

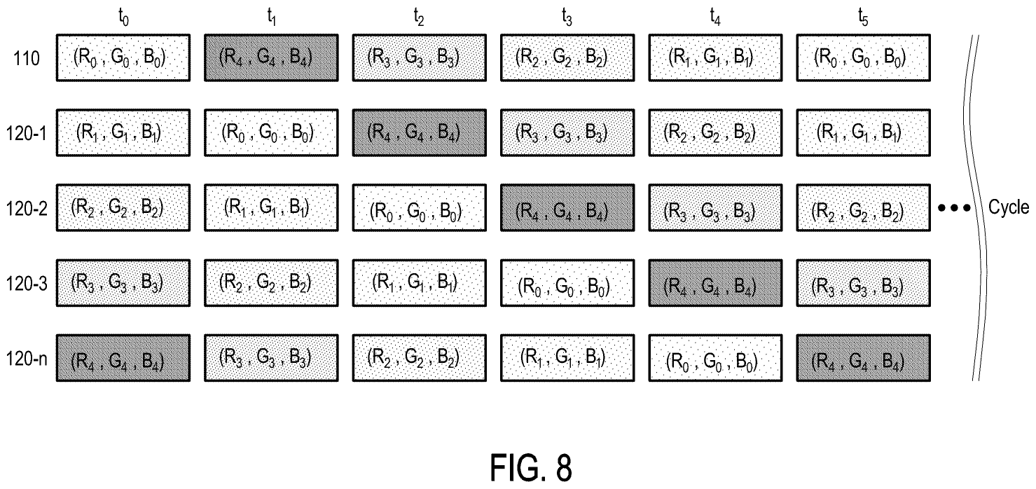

For example, FIG. 8 is a schematic diagram of the color sequences at multiple time points according to an embodiment of the disclosure. Referring to FIG. 8, it is assumed that the light emitting device 120-1 is closest to the reference device RS, the light emitting device 120-n is farthest from the reference device RS, and so on. At time point to, the color sequence is [(R₀, G₀, B₀) (R₁, G₁, B₁) (R₂, G₂, B₂) (R₃, G₃, B₃) (R₄, G₄, B₄)], where n is 4 in this example. The color value of the reference device RS (that is, RGB value (R₀, G₀, B₀)) is placed first in the color sequence, the color value of the light emitting device 120-n (that is, RGB value (R₄, G₄, B₄)) is placed last in the color sequence, and the rest are arranged according to distance.

Subsequently, the processor 112 may determine a second color sequence of these light emitting devices 120 at a second time point. The second color sequence is obtained by arranging the color values corresponding to these light emitting devices 120 according to the distances of these light emitting devices 120 relative to the reference device RS at the second time point. It is worth noting that the second color sequence is a variation of the first color sequence based on cyclic arrangement. That is to say, at different time points, the color values in multiple color sequences are cyclically arranged.

Taking FIG. 8 as an example, at the next time point after time point to (that is, time point t₁), the color sequence is [(R₄, G₄, B₄) (R₀, G₀, B₀) (R₁, G₁, B₁) (R₂, G₂, B₂) (R₃, G₃, B₃)]. That is to say, the color value of the reference device RS at time point t₁ is the color value of the light emitting device 120-n at time point to, the color value of the light emitting device 120-1 at time point t₁ is the color value of the reference device RS at time point to, the color value of the light emitting device 120-2 at time point t₁ is the color value of the light emitting device 120-1 at time point to, the color value of the light emitting device 120-3 at time point t₁ is the color value of the light emitting device 120-2 at time point to, and the color value of the light emitting device 120-n at time point t₁ is the color value of the light emitting device 120-3 at time point to.

Accordingly, the color sequence at time point t₂ is [(R₃, G₃, B₃) (R₄, G₄, B₄) (R₀, G₀, B₀) (R₁, G₁, B₁) (R₂, G₂, B₂)], the color sequence at time point t₃ is [(R₂, G₂, B₂) (R₃, G₃, B₃) (R₄, G₄, B₄) (R₀, G₀, B₀) (R₁, G₁, B₁)], and the color sequence at time point t₄ is [(R₁, G₁, B₁) (R₂, G₂, B₂) (R₃, G₃, B₃) (R₄, G₄, B₄) (R₀, G₀, B₀)]. Then, the color sequence at time point t₅ returns to the color sequence at time point to [(R₀, G₀, B₀) (R₁, G₁, B₁) (R₂, G₂, B₂) (R₃, G₃, B₃) (R₄, G₄, B₄)].

As time changes, the lighting control system 1 as a whole displays a color-changing light flowing in a fixed direction. The processor 112 defines the head-end light color with the current reference device RS as the gradient color center, and defines the tail-end light color using the reference device RS as the very end of the flow. Within the linear gradient range established in the RGB two-dimensional color space, a relative time delay is applied corresponding to the actual distance between each light emitting device 120 and the reference device RS. For example, the user may specify the maximum time delay t_max as the time required for the same color light to flow from the reference device RS to the farthest light emitting device 120. Thereby, the light emitting devices 120 located at different positions may generate an effect of circular diffusion flow with the reference device RS as the center.

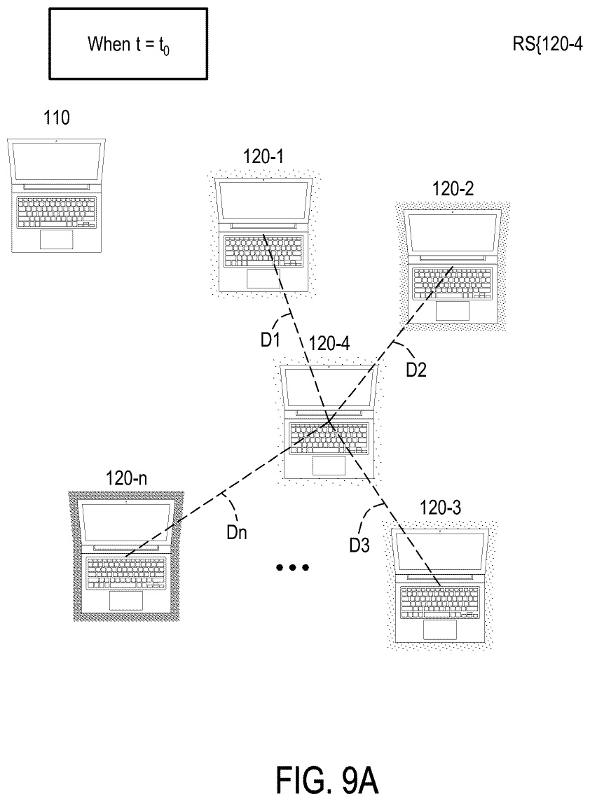

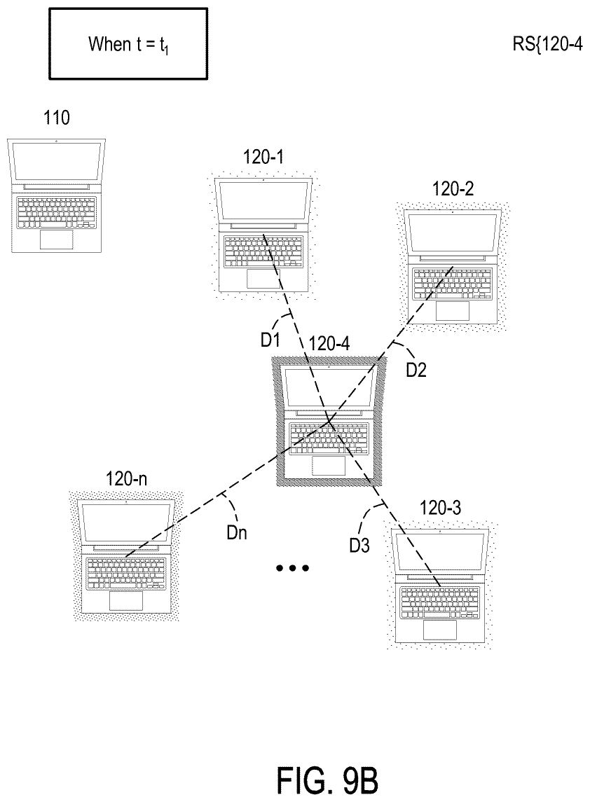

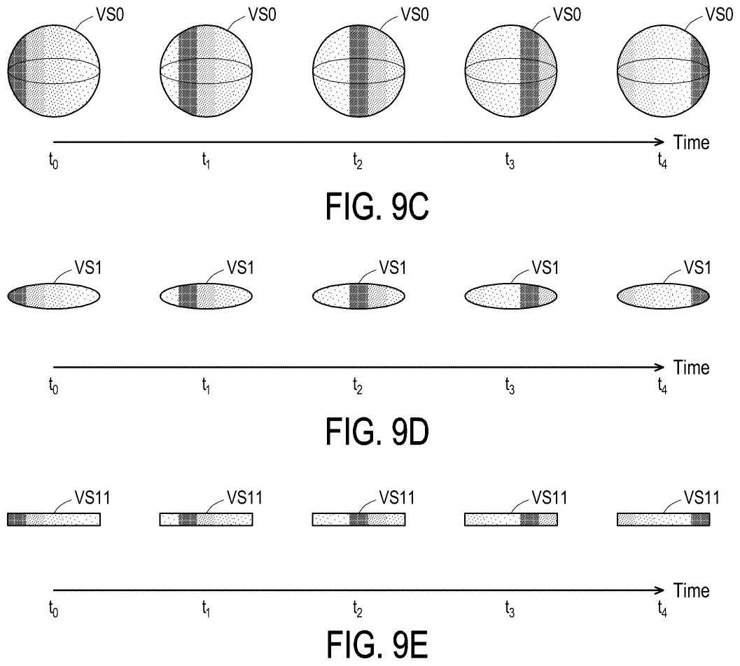

For example, FIG. 9A is a schematic diagram of the lighting effect at time point t₀ according to an embodiment of the disclosure. Referring to FIG. 8 and FIG. 9A, at time point t=t₀, the light elements 123 of the reference device RS and the light emitting devices 120 emit light according to the color sequence [(R₀, G₀, B₀) (R₁, G₁, B₁) (R₂, G₂, B₂) (R₃, G₃, B₃) (R₄, G₄, B₄)] shown in FIG. 8.

FIG. 9B is a schematic diagram of the lighting effect at another time point t₁ according to an embodiment of the disclosure. Referring to FIG. 8 and FIG. 9B, at time point t=t₁, the light elements 123 of the reference device RS and the light emitting devices 120 emit light according to the color sequence [(R₄, G₄, B₄) (R₀, G₀, B₀) (R₁, G₁, B₁) (R₂, G₂, B₂) (R₃, G₃, B₃)] shown in FIG. 8.

It is worth noting that the positions of the reference device RS and/or the light emitting devices 120 may change. In an embodiment, the processor 112 may control one or more light elements 123 of the light emitting devices 120 based on new relative positions of the reference device RS and one or more light emitting devices 120. The new relative positions of the reference device RS and/or one or more light emitting devices 120 are different from the (original) distance between the reference device RS and/or one or more light emitting devices 120. That is, the light color of the light element changes according to the new position.

FIG. 9C is a schematic diagram illustrating the lighting effects at multiple time points for the virtual space VS0 according to an embodiment of the disclosure. Referring to FIG. 9C, it is assumed that the color variation cycle T is t₄, and the color variation cycle is gradually varying from RGB value (r_{c}, g_{c}, b_{c}) to RGB value (r′_{c}, g′_{c}, b′_{c}) and then returning to RGB value (r_{c}, g_{c}, b_{c}). The color variation direction of the color space of the sphere is in the normal direction from (x_{c}, y_{c},) toward (−x_{c}, −y_{c},). The equations for the color cycle variation of the color space of the sphere are as follows:

$$( t ) = r + sin ( \frac{2 π t}{T} ) \cdot \frac{{r}_{{x}^{′} s} - {r}_{xs}}{2} \qquad ( 32 )$$

$$G ( t ) = g + sin ( \frac{2 π t}{T} ) \cdot \frac{{g}_{{x}^{′} s} - {g}_{xs}}{2} \qquad ( 33 )$$

$$B ( t ) = b + sin ( \frac{2 π t}{T} ) \cdot \frac{{b}_{{x}^{′} s} - {b}_{xs}}{2} , \qquad ( 34 )$$

where the definitions of the parameters may refer to equations (20) to (22), which will not be repeated here.

FIG. 9D is a schematic diagram illustrating the lighting effects at multiple time points for the virtual space VS1 according to an embodiment of the disclosure. Referring to FIG. 9D, it is assumed that the color variation cycle T is t₄, and the color variation cycle is gradually varying from RGB value (r_{c}, g_{c}, b_{c}) to RGB value (r′_{c}, g′_{c}, b′_{c}) and then returning to RGB value (r_{c}, g_{c}, b_{c}). The color variation direction of the color space of the circle is in the normal direction from (x_{c}, y_{c},) toward (−x_{c}, −y_{c},). The equations for the color cycle variation of the color space of the circle are as follows:

$$( t ) = r + sin ( \frac{2 π t}{T} ) \cdot \frac{{r}_{c}^{′} - {r}_{c}}{2} \qquad ( 35 )$$

$$G ( t ) = g + sin ( \frac{2 π t}{T} ) \cdot \frac{{g}_{c}^{′} - {g}_{c}}{2} \qquad ( 36 )$$

$$B ( t ) = b + sin ( \frac{2 π t}{T} ) \cdot \frac{{b}_{c - {b}_{c}}^{′}}{2} , \qquad ( 37 )$$

where the definitions of the parameters may refer to equations (23) to (25), which will not be repeated here.

FIG. 9E is a schematic diagram illustrating the lighting effects at multiple time points for the virtual space VS11 according to an embodiment of the disclosure. Referring to FIG. 9E, it is assumed that the color variation cycle T is t₄. The color at the starting point of the virtual space VS11 (for example, located at the left end of the line segment) varies at a constant speed from RGB value (R₀, G₀, B₀) gradually to RGB value (Rₑ, Gₑ, Bₑ) and then returns to RGB value (R₀, G₀, B₀), going through one variation cycle of T. The color at the ending point of the virtual space VS11 (for example, located at the right end of the line segment) varies at a constant speed from RGB value (Rₑ, Gₑ, Bₑ) gradually to RGB value (R₀, G₀, B₀) and then returns to RGB value (Rₑ, Gₑ, Bₑ), going through one variation cycle of T. The RGB value (Rᵢⱼₘ, Gᵢⱼₘ, Bᵢⱼₘ) at any point (corresponding to the position of the light emitting device 120) is linked with the RGB value (R₀, G₀, B₀) of the starting point and the RGB value (Rₑ, Gₑ, Bₑ) of the ending point according to gradual variation rules. It should be noted that the parameter definitions in this embodiment may refer to equations (29) to (31), which will not be repeated here.

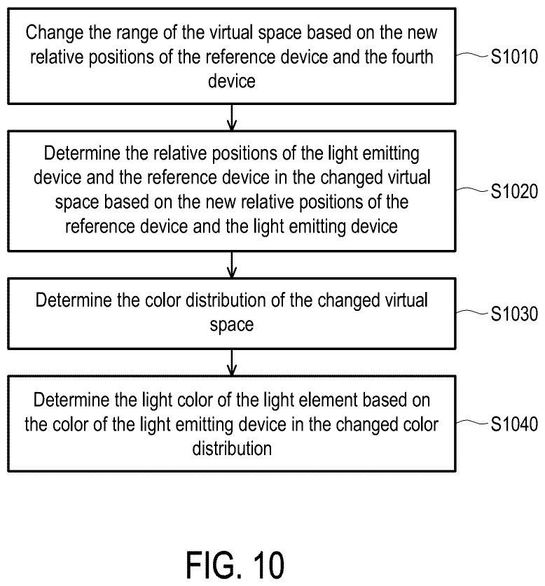

FIG. 10 is a flowchart of a lighting linkage method for a new position according to an embodiment of the disclosure. Referring to FIG. 10, one or more light emitting devices 120 include a fourth device, and the fourth device is the farthest from the reference device RS. The processor 112 may change the range of the virtual space based on the new relative positions of the reference device RS and the fourth device (step S1010). In an embodiment, the range of the virtual space is determined based on the reference device RS as the center and the distance to the farthest light emitting device 120 as the maximum distance. Therefore, when the positions of the reference device RS and/or the light emitting device 120 change, the range of the virtual space changes correspondingly.

In an embodiment, the reference device RS and/or the light emitting device 120 may detect whether they have moved. If movement occurs, the reference device RS and/or the light emitting device 120 further detect whether they have become stationary. Then, if the reference device RS and/or the light emitting device 120 are stationary, the reference device RS and/or the light emitting device 120 further calculate the stationary time, and determine whether this stationary time exceeds a time threshold value (for example, 3, 5, or 10 seconds). If the stationary time corresponding to the light emitting device 120 exceeds the time threshold value, the light emitting device 120 may actively transmit a distance signal. Alternatively, if the stationary time corresponding to the reference device RS exceeds the time threshold value, the reference device RS may actively transmit a new ranging signal. The main control apparatus 110 or the reference device RS may determine the new distance based on the distance/the return time of the new return signal and/or the received power.

In an embodiment, the processor 122 of the reference device RS or the light emitting device 120 may transmit a ranging signal periodically or non-periodically via the communication transceiver 121. When the processor 122 detects a change in the return time of the return signal or a change in the received power, the processor 122 determines that the position of the corresponding light emitting device 120 has changed. At subsequent time points, the processor 122 may confirm that the position of the light emitting device 120 has changed based on the received return signal.

Since the maximum distance between the reference device RS and the light emitting device 120 is used to define the range of the virtual space, the processor 112 may find the new maximum distance from the new distances between the light emitting devices 120 and the reference device RS.

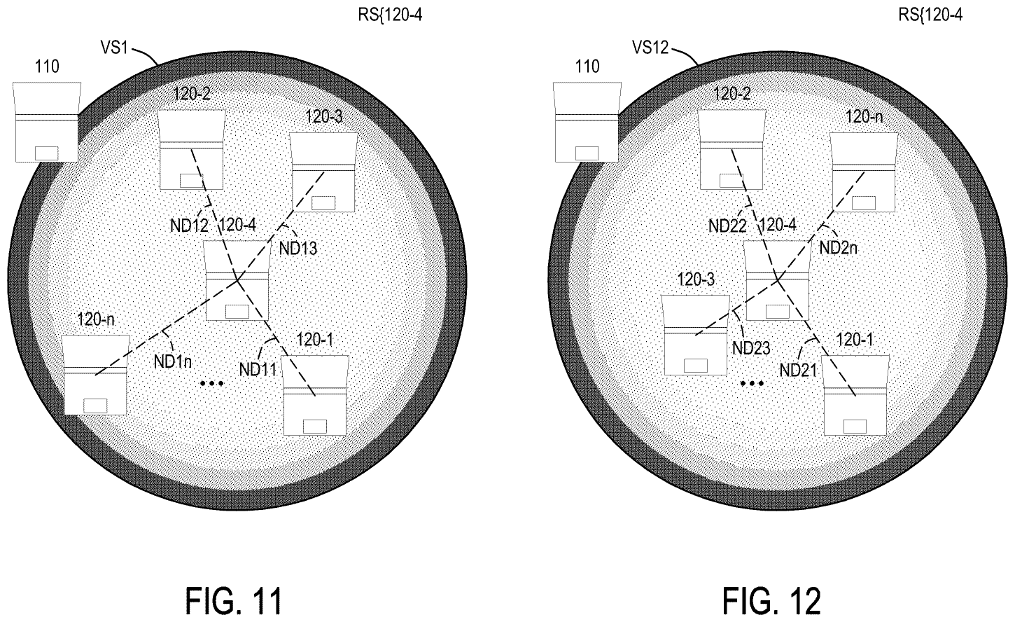

In an embodiment, the new maximum distance is equal to (the original maximum distance). For example, FIG. 11 is a schematic diagram illustrating the continued use of the virtual space VS1 according to an embodiment of the disclosure. Referring to FIG. 7 and FIG. 11, compared to FIG. 7, the positions of the light emitting devices 120-1 to 120-n in FIG. 11 have all changed, and the light emitting devices 120-1 to 120-n are separated from the reference device RS by new distances ND11, ND12, ND13 to ND1n respectively. The processor 112 finds the new maximum distance from the new distances ND11, ND12, ND13 to ND1n between the light emitting devices 120-1 to 120-n and the reference device RS. For example, the new distance ND1n is the maximum distance. The new distance ND1n is still equal to the distance D3. Since the maximum distance has not changed, the processor 112 continues to use the virtual space VS1. In addition, the processor 112 also continues to use the color radius of the virtual space VS1.

FIG. 12 is a schematic diagram illustrating the color distribution of the reduced virtual space VS12 according to an embodiment of the disclosure. Referring to FIG. 7 and FIG. 12, compared to FIG. 7, the positions of the light emitting devices 120-1 to 120-n in FIG. 12 have all changed, and the light emitting devices 120-1 to 120-n are separated from the reference device RS by new distances ND21, ND22, ND23 to ND2n respectively. The processor 112 finds the new maximum distance from the new distances ND21, ND22, ND23 to ND2n between the light emitting devices 120-1 to 120-n and the reference device RS. For example, the new distance ND22 is the new maximum distance. At this time, the new distance ND22 is not equal to the distance D3. Since the maximum distance has changed (that is, the new maximum distance is greater than the original maximum distance), the processor 112 changes the virtual space VS1 to the changed virtual space VS12 as shown in FIG. 12. At this time, the processor 112 determines the range and color radius of the virtual space VS12 based on the new maximum distance (that is, the new distance ND22). Compared to the virtual space VS1 in FIG. 7, the range and color radius of the virtual space VS12 are reduced.

It should be noted that when the new maximum distance is not equal to the original maximum distance, the changed virtual space may also be an enlarged virtual space VS1 and/or color radius.

Referring to FIG. 10, the processor 112 may determine the relative positions of the light emitting devices 120 and the reference device RS in the changed virtual space based on the new relative positions of the reference device RS and one or more light emitting devices 120 (step S1020). Specifically, the processor 112 may, based on the new distances obtained through ranging and with the reference device RS as the center, map the positions of the light emitting devices 120 and the reference device RS in the real space to the same positions in the changed virtual space respectively. Taking FIG. 12 as an example, the new distance ND21 between the light emitting device 120-1 and the reference device RS is the same as the distance in the changed virtual space, or the distance may be proportionally reduced or enlarged according to requirements.

The processor 112 may determine the color distribution of the changed virtual space (step S1030). Similarly, each position in the changed virtual space corresponds to one color. The color distribution thereof is the distribution of color at each position in the changed virtual space. In addition, as previously described, the color distribution may be defined by the color value upper limit and the color value lower limit.

The processor 112 may determine the color of the light emitting device 120 in the changed color distribution based on the relative position of the light emitting device 120 in the changed virtual space (step S1040). Then, the processor 112 may determine the light color of one or more light elements 123 based on the color of the light emitting device 120 in the changed color distribution (step S1050). Specifically, each light emitting device 120 is located at a specific position in the changed virtual space, and the color distribution of the changed virtual space has been defined. Therefore, the processor 112 may know the color at the position where the light emitting device 120 is located in the changed color distribution, as the conversion function in equations (2) to (4) determines new RGB value based on the new distance and new maximum distance. Then, the main control apparatus 110 transmits the new RGB value to the light emitting device 120 respectively, which may change the light color of the light element 123.

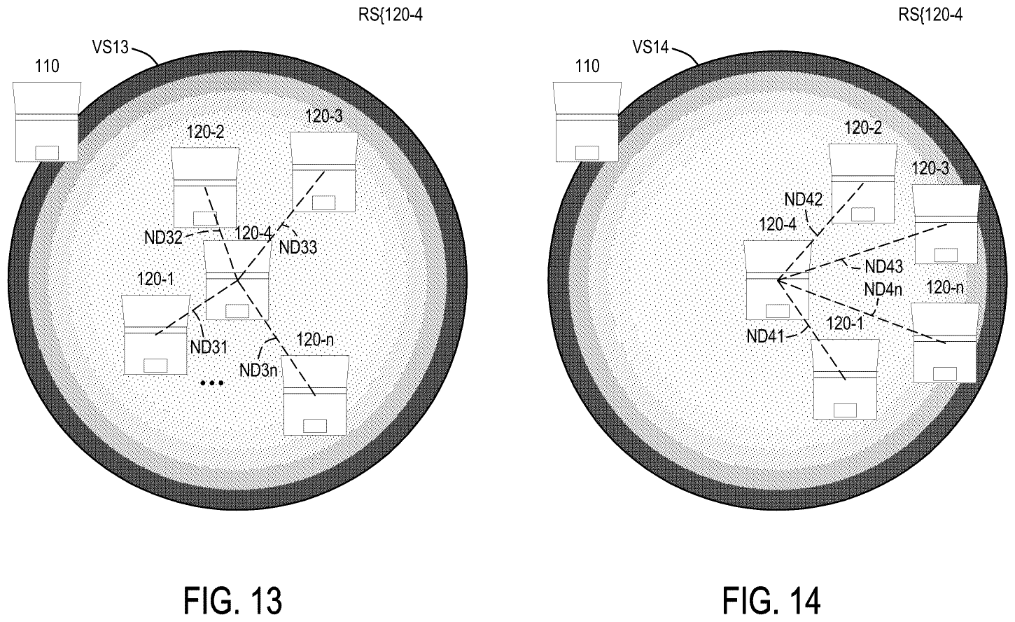

In an embodiment, when the position of the reference device RS changes, the processor 112 keeps the color value lower limit of the changed color distribution the same as the color value lower limit of the (original) color distribution. For example, FIG. 13 is a schematic diagram illustrating the color distribution of a reduced virtual space according to an embodiment of the disclosure. Referring to FIG. 7 and FIG. 13, compared to FIG. 7, the position of the reference device RS in FIG. 13 has changed (for example, moved from coordinate (0, 0) to new coordinate (x0, y0)), and is separated from the light emitting devices 120-1 to 120-n by new distances ND31, ND32, ND33 to ND3n respectively. The processor 112 finds the new maximum distance from the new distances ND31, ND32, ND33 to ND3n between the light emitting devices 120-1 to 120-n and the reference device RS. For example, the new distance ND3n is the new maximum distance. At this time, the new distance ND3n is not equal to the distance D3. Since the maximum distance has changed (that is, the new maximum distance is smaller than the original maximum distance), the processor 112 changes the virtual space VS1 to the changed virtual space VS13 as shown in FIG. 13. At this time, the processor 112 determines the range and color radius of the virtual space VS13 based on the new maximum distance (that is, the new distance ND3n). Compared to the virtual space VS1 in FIG. 7, the range of the virtual space VS13 is reduced, but the color radius remains unchanged.

FIG. 14 is a schematic diagram illustrating the color distribution of an enlarged virtual space according to an embodiment of the disclosure. Referring to FIG. 7 and FIG. 14, compared to FIG. 7, the position of the reference device RS in FIG. 14 has changed (for example, moved from coordinate (0, 0) to new coordinate (x0, y0)), and is separated from the light emitting devices 120-1 to 120-n by new distances ND41, ND42, ND43 to ND4n respectively. The processor 112 finds the new maximum distance from the new distances ND41, ND42, ND43 to ND4n between the light emitting devices 120-1 to 120-n and the reference device RS. For example, the new distance ND4n is the new maximum distance. At this time, the new distance ND4n is not equal to the distance D3. Since the maximum distance has changed (that is, the new maximum distance is greater than the original maximum distance), the processor 112 changes the virtual space VS1 to the changed virtual space VS14 as shown in FIG. 14. At this time, the processor 112 determines the range and color radius of the virtual space VS14 based on the new maximum distance (that is, the new distance ND4n). Compared to the virtual space VS1 in FIG. 7, the range of the virtual space VS14 is enlarged, but the color radius remains unchanged.

In an embodiment, when the position of the reference device RS changes, the processor 112 may determine the color value lower limit of the changed color distribution based on the new position of the reference device RS, so that the color value lower limit of the changed color distribution is different from the color value lower limit of the (original) color distribution.

In an embodiment, the processor 112 receives a user command via the input device 113, and this user command is used to read the new coordinate (x0, y0) and coordinate (0, 0) of the reference device RS. The processor 112 moves the center of the changed virtual space from the new coordinate (x0, y0) to coordinate (0, 0). The processor 112 determines the new RGB value (new R₀, new G₀, new B₀) of the reference device RS based on the coordinate (0, 0), new coordinate (x0, y0), color value lower limit (for example, RGB value (R₀, G₀, B₀)), new maximum distance Yₙₘₐₓ, and color radius:

$$new {R}_{0} = {R}_{0} + \frac{{Y}_{0} \times {r}_{color}}{{Y}_{n max}} \qquad ( 38 )$$

$$new {G}_{0} = {G}_{0} + \frac{{Y}_{0} \times {r}_{color}}{{Y}_{n max}} \qquad ( 39 )$$

$$new {B}_{0} = {B}_{0} + \frac{{Y}_{0} \times {r}_{color}}{{Y}_{n max}} , \qquad ( 40 )$$

$$where {Y}_{0} = \sqrt{{( x 0 - 0 )}^{2} + {( y 0 - 0 )}^{2}} .$$

Subsequently, the processor 112 may determine the new RGB values (new R₁, new G₁, new B₁) to (new Rₙ, new Gₙ, new Bₙ) of the light emitting devices 120 based on the new RGB value (new R₀, new G₀, new B₀), new distance, new maximum distance, and color radius.

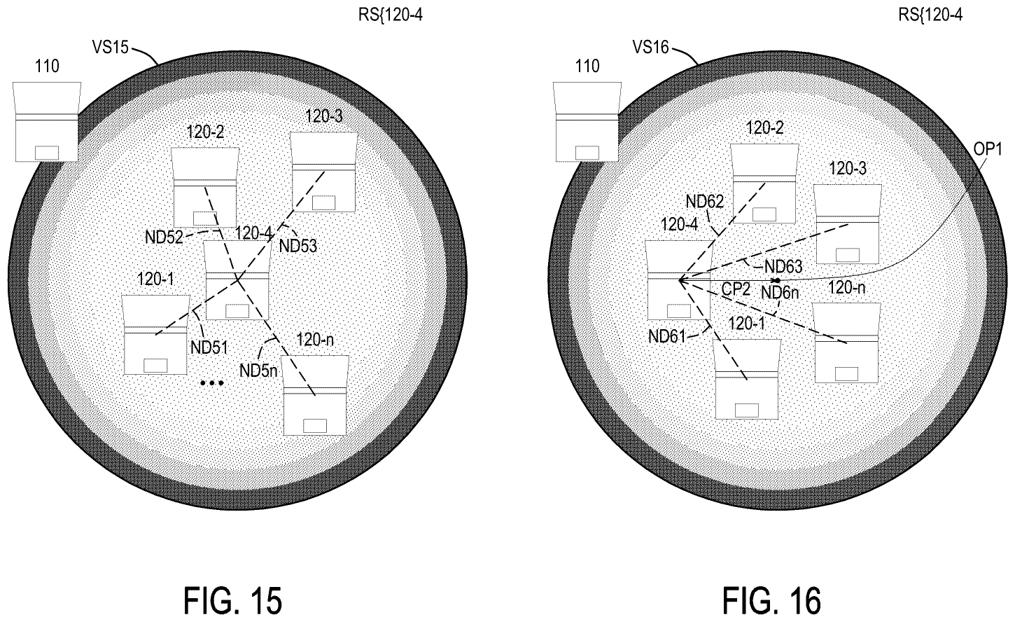

For example, FIG. 15 is a schematic diagram illustrating origin update according to an embodiment of the disclosure. Referring to FIG. 7 and FIG. 15, compared to FIG. 7, the position of the reference device RS in FIG. 15 has changed (for example, moved from coordinate (0, 0) to new coordinate (x0, y0)), and is separated from the light emitting devices 120-1 to 120-n by new distances ND51, ND52, ND53 to ND5n respectively. The processor 112 finds the new maximum distance from the new distances ND51, ND52, ND53 to ND5n between the light emitting devices 120-1 to 120-n and the reference device RS. For example, the new distance ND5n is the new maximum distance. At this time, the new distance ND5n is not equal to the distance D3. Since the maximum distance has changed (that is, the new maximum distance is smaller than the original maximum distance), the processor 112 changes the virtual space VS1 to the changed virtual space VS15 as shown in FIG. 15. At this time, the processor 112 determines the range and color radius of the virtual space VS15 based on the new maximum distance (that is, the new distance ND5n). Compared to the virtual space VS1 in FIG. 7, the range and color radius of the virtual space VS15 remain unchanged, but the reference device RS is moved from the new coordinate (x0, y0) to coordinate (0, 0).

FIG. 16 is a schematic diagram illustrating origin update according to another embodiment of the disclosure. Referring to FIG. 7 and FIG. 16, compared to FIG. 7, the position of the reference device RS in FIG. 16 has changed (for example, moved from coordinate (0, 0) to new coordinate (x0, y0)), and is separated from the light emitting devices 120-1 to 120-n by new distances ND61, ND62, ND63 to ND6n respectively. The processor 112 finds the new maximum distance from the new distances ND61, ND62, ND63 to ND6n between the light emitting devices 120-1 to 120-n and the reference device RS. For example, the new distance ND6n is the new maximum distance. At this time, the new distance ND6n is not equal to the distance D3. Since the maximum distance has changed (that is, the new maximum distance is greater than the original maximum distance), the processor 112 changes the virtual space VS1 to the changed virtual space VS16 as shown in FIG. 16. At this time, the processor 112 determines the range and color radius of the virtual space VS16 based on the new maximum distance (that is, the new distance ND6n). Compared to the virtual space VS1 in FIG. 7, the range and color radius of the virtual space VS16 remain unchanged, but the reference device RS is moved from the new coordinate (x0, y0) at the position CP2 to coordinate (0, 0) at the position OP1.

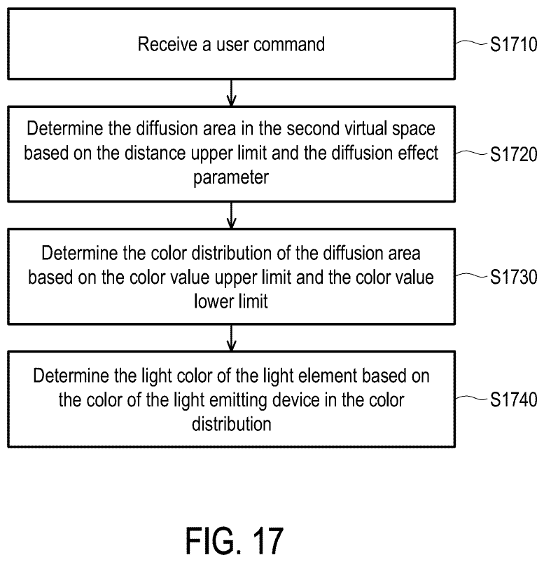

FIG. 17 is a flowchart of a diffusion linkage method according to an embodiment of the disclosure. Referring to FIG. 17, the processor 112 may receive one or more user commands via the input device 113 (step S1710). The one or more user commands indicate the distance upper limit Y_{dmax}, color value upper limit (for example, RGB value (R_{dmax}, G_{dmax}, B_{dmax})), and color value lower limit (for example, RGB value (R_{d0}, G_{d0}, B_{d0})). In an embodiment, the user command further indicates the coordinate (0, 0) of the center.

The processor 112 may determine a second virtual space based on the distance upper limit Y_{dmax}. The second virtual space is also a virtual space established by the lighting control software executed by the main control apparatus 110. The second virtual space may be used to set or present the relative positions between devices and the light colors of the light elements 120.

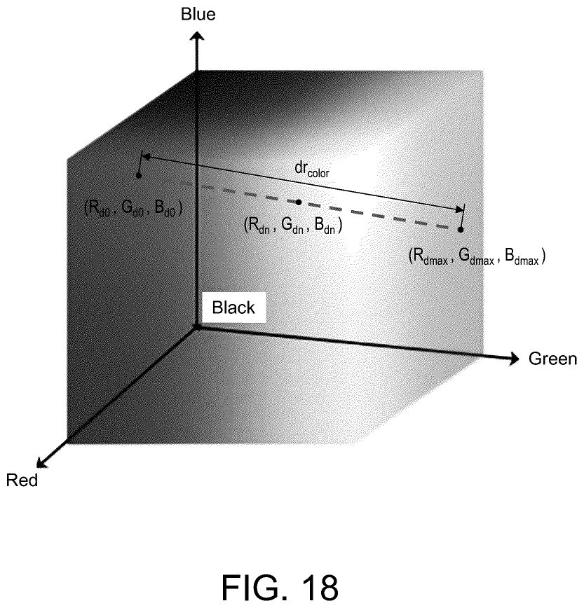

The processor 112 may determine a second color radius r_{dcolor} based on the color value upper limit (for example, RGB value (R_{dmax}, G_{dmax}, B_{dmax})) and the color value lower limit (for example, RGB value (R_{d0}, G_{d0}, B_{d0})). For example, FIG. 18 is a schematic diagram illustrating the color distribution definition based on a user command according to an embodiment of the disclosure. Referring to FIG. 18, the second color radius r_{dcolor} is:

$${r}_{dcolor} = \sqrt{{( {R}_{d 0} - {R}_{dmax} )}^{2} + {( {G}_{d 0} - {G}_{dmax} )}^{2} + {( {B}_{d 0} - {B}_{dmax} )}^{2}} . \qquad ( 41 )$$

The processor 112 may determine a diffusion area based on the distance upper limit and a diffusion effect parameter (step S1720). The diffusion effect parameter defines a variation of the diffusion area over time. The diffusion effect is light that gradually varies from the color value lower limit (for example, RGB value (R_{d0}, G_{d0}, B_{d0})) corresponding to the touch coordinate (0, 0), through the second color radius r_{dcolor}, to the color value upper limit (for example, RGB value (R_{dmax}, G_{dmax}, B_{dmax})) corresponding to the distance upper limit Y_{dmax}.

The diffusion effect parameter is, for example, diffusion time T₀ and preset diffusion speed V₀. The diffusion area A₀ is, for example:

$${A}_{0} = π ( {( {T}_{0} \times {V}_{0} + {Y}_{dmax} )}^{2} - {( {T}_{0} \times {V}_{0} )}^{2} ) , \qquad ( 42 )$$

where the center of the ring-shaped diffusion area A₀ is located at coordinate (0, 0).

The processor 112 may determine the color distribution of the diffusion area based on the color value upper limit and the color value lower limit (step S1730). The processor 112 may correspond the color at the position farthest from the center of the diffusion area A₀ (located on the outer contour of the diffusion area A₀) to the color value upper limit of the color distribution, and correspond the color at the center to the color value lower limit of the color distribution.

Next, the processor 112 may determine the light color of one or more light elements 123 based on the color of the light emitting device 120 in the color distribution (step S1740). Each light emitting device 120 is located at a specific position in the virtual space, and the color distribution of the diffusion area has been defined. Therefore, the processor 112 may know the color at the position where the light emitting device 120 is located in the color distribution. Taking FIG. 18 as an example, R_{dn} is the red value corresponding to a position at a distance Yₙ (where n is a positive integer) from the center (for example, the position of the reference device RS) in the diffusion area A₀, G_{dn} is the green value corresponding to a position at a distance Yₙ from the center (for example, the position of the reference device RS) in the diffusion area A₀, and Bₙ is the blue value corresponding to a position at a distance Yₙ from the center (for example, the position of the reference device RS) in the diffusion area A₀.

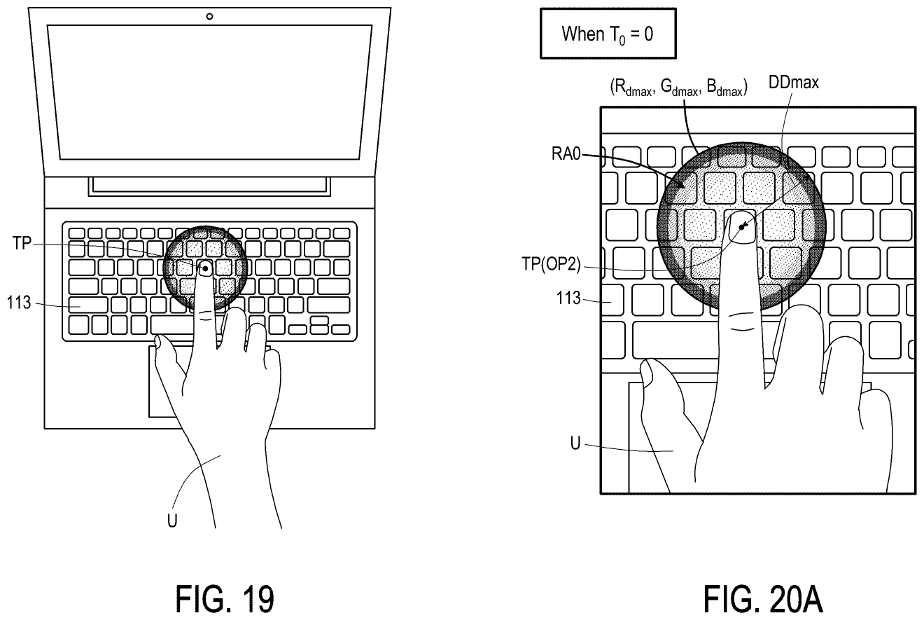

The following describes an application scenario. FIG. 19 is a schematic diagram of the user command according to an embodiment of the disclosure. Referring to FIG. 19, first, the RGB values of the color value upper limit and the color value lower limit shown in FIG. 18 are defined. Next, the user command is a touch command from the user U received via the input device 113 (using a touch pad as an example). When a finger of the user U touches a certain position on the input device 113, the influence on the lighting effect: a ripple effect is presented that diffuses outward from the finger as the center of the diffusion area. That is, the touch command indicates the center of the diffusion area.

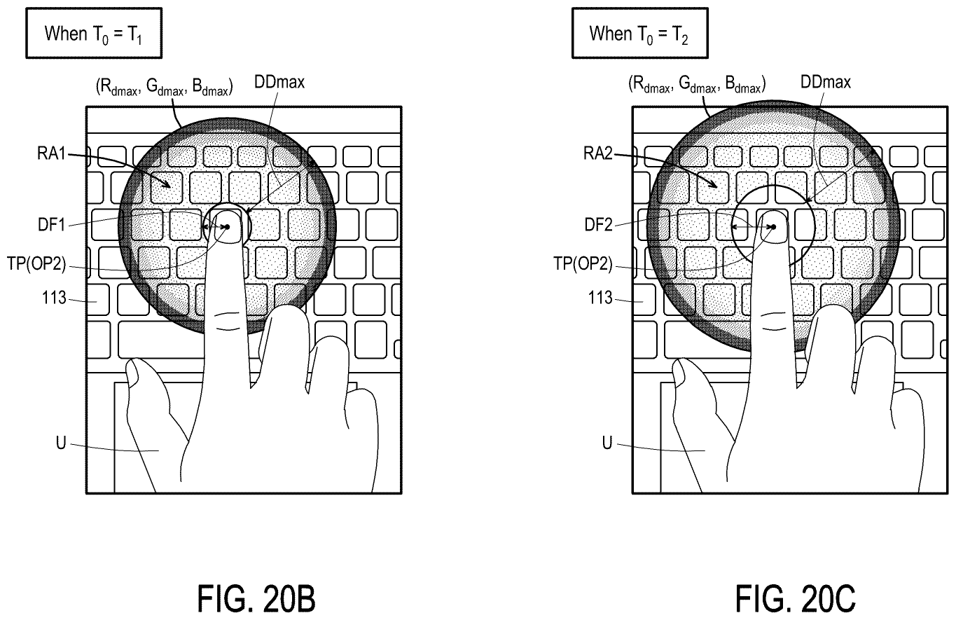

FIG. 20A is a schematic diagram illustrating the color distribution of the diffusion area RA0 at the initial time point according to an embodiment of the disclosure. Referring to FIG. 20A, when the diffusion time T₀ is 0 (that is, the initial time point), the diffusion area RA0 is a circle. The finger of the user U touches the touch point TP and corresponds to the center OP2 of the diffusion area RA0. The radius of the diffusion area RA0 is a distance upper limit DDmax. When located at a position at the distance upper limit DDmax from the center OP2, the color of the light emitting device 120 is the color value upper limit (for example, RGB value (R_{dmax}, G_{dmax}, B_{dmax})).

FIG. 20B is a schematic diagram illustrating the color distribution of the diffusion area RA1 at another time point T₁ according to an embodiment of the disclosure. Referring to FIG. 20B, when the diffusion time T₀ is at time point T₁, the diffusion area RA1 is a ring. The inner circle of the diffusion area RA1 is at a distance DF1 from the touch point TP (that is, the center OP2). The distance DF1 is, for example, T₁×V₀. The distance between the inner circle and the outer circle of the diffusion area RA1 is the distance upper limit DDmax.

FIG. 20C is a schematic diagram illustrating the color distribution of the diffusion area RA2 at another time point T₂ according to an embodiment of the disclosure. Referring to FIG. 20C, when the diffusion time T₀ is at time point T₂, the diffusion area RA2 is a ring. The inner circle of the diffusion area RA2 is at a distance DF2 from the touch point TP (that is, the center OP2). The distance DF2 is, for example, T₂×V₀. The distance between the inner circle and the outer circle of the diffusion area RA2 remains as the distance upper limit DDmax.

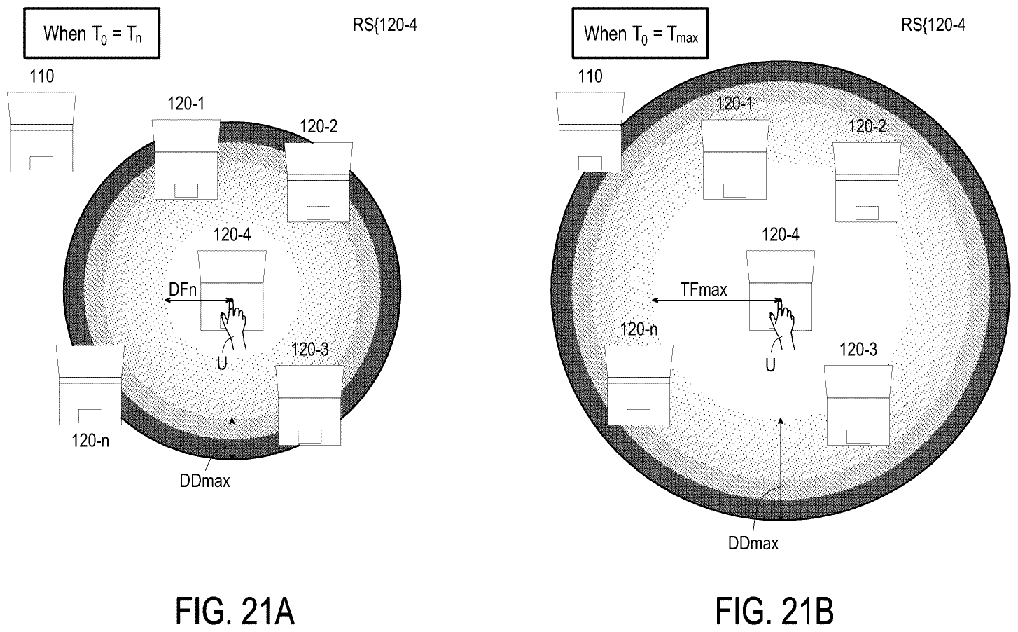

FIG. 21A is a schematic diagram illustrating the color distribution of the diffusion area RAn at another time point Tₙ (n is a positive integer) according to an embodiment of the disclosure. Referring to FIG. 21A, when the diffusion time T₀ is at time point Tₙ, the diffusion area RAn is a ring. The inner circle of the diffusion area RAn is at a distance DFn from the center. The distance DFn is, for example, Tₙ×V₀. The distance between the inner circle and the outer circle of the diffusion area RAn remains as the distance upper limit DDmax. The light colors of the light emitting devices 120-1 to 120-n correspond to the colors at the corresponding positions in the color distribution of the diffusion area RAn.

FIG. 21B is a schematic diagram illustrating the color distribution of the diffusion area RAmax at the maximum diffusion time point Tₘₐₓ according to an embodiment of the disclosure. Referring to FIG. 21B, when the diffusion time T₀ is at time point Tₘₐₓ, the diffusion area RAmax is a ring. The inner circle of the diffusion area RAn is at a distance DFmax from the center. The distance DFmax is, for example, Tₘₐₓ×V₀. The distance between the inner circle and the outer circle of the diffusion area RAmax remains as the distance upper limit DDmax. The light colors of the light emitting devices 120-1 to 120-n correspond to the colors at the corresponding positions in the color distribution of the diffusion area RAmax.

In summary, in the lighting linkage method, the main control apparatus for lighting control, and the lighting control system according to the embodiments of the disclosure, a virtual space is defined for multiple light emitting devices connected by wireless communication technology to establish the position relationship between the devices. Based on this position relationship, the light emitting devices are mapped to the virtual space. The virtual space corresponds to the color distribution, enabling the light emitting devices at different positions to present lighting linkage with different colors. The main control apparatus can control the lighting linkage relationship with the light emitting devices.

Although the disclosure has been described with reference to the above embodiments, they are not intended to limit the disclosure. Those skilled in the art may make some modifications and changes without departing from the spirit and scope of the disclosure. Therefore, the scope of protection of the disclosure should be defined by the appended claims.

What is claimed is:

1. A main control apparatus for lighting control, comprising:
a communication transceiver configured to transmit or receive a signal; and
a processor coupled to the communication transceiver and configured to:
obtain information about relative positions of a reference device and at least one light emitting device via the communication transceiver, wherein the relative positions of the reference device and the at least one light emitting device are measured via a wireless signal, wherein the reference device and the at least one light emitting device are connected using a communication protocol corresponding to the wireless signal, and each of the at least one light emitting device comprises at least one light element.

2. The main control apparatus according to claim 1, wherein the processor is further configured to:
control the at least one light element of the at least one light emitting device based on the relative positions of the reference device and the at least one light emitting device.

3. The main control apparatus according to claim 1, further comprising:
at least one second light element coupled to the processor, wherein the processor is further configured to:
control the at least one second light element based on relative positions of the reference device and the main control apparatus.

4. The main control apparatus according to claim 1, wherein the at least one light emitting device comprises a first device, and the wireless signal is a return signal transmitted from the first device to the reference device,
at least one of a return time, a signal strength, and a phase shift of the return signal is used to determine a distance between the reference device and the first device; and
an arrival angle of the return signal is used to determine an angle of the first device relative to the reference device.

5. The main control apparatus according to claim 1, wherein the at least one light emitting device comprises a second device, the second device is separated from the reference device at a farthest distance, and the processor is further configured to:
determine a range of a virtual space based on a distance between the reference device and the second device, wherein the reference device is located at a center of the virtual space;
determine relative positions of the at least one light emitting device and the reference device in the virtual space based on the relative positions of the reference device and the at least one light emitting device;
determine a color distribution of the virtual space;
determine a color of the at least one light emitting device in the color distribution based on the relative position of the at least one light emitting device in the virtual space; and
determine a light color of the at least one light element based on the color of the at least one light emitting device in the color distribution.

6. The main control apparatus according to claim 5, wherein the processor is further configured to:
correspond a color of the second device to a color value upper limit of the color distribution; and
correspond a color of the reference device to a color value lower limit of the color distribution.

7. The main control apparatus according to claim 5, wherein the processor is further configured to:
determine a conversion function of the color distribution, wherein
in the conversion function, a color value of the color distribution gradually varies from a color value lower limit at the center to a color value upper limit; and
obtain the color of the at least one light emitting device in the color distribution by inputting the information about the relative positions of the reference device and the at least one light emitting device to the conversion function.

8. The main control apparatus according to claim 5, wherein the processor is further configured to:
determine a conversion function of the color distribution, wherein
in the conversion function, a color value of the color distribution gradually varies from a color value at a first point of the virtual space to a color value at a second point of the virtual space; and
obtain the color of the at least one light emitting device in the color distribution by inputting the information about the relative positions of the reference device and the at least one light emitting device to the conversion function.

9. The main control apparatus according to claim 5, wherein the at least one light emitting device comprises a third device, and the processor is further configured to:
transmit a lighting indication signal via the communication transceiver, wherein the lighting indication signal comprises a color value of a color corresponding to the third device.

10. The main control apparatus according to claim 5, wherein the at least one light emitting device comprises a plurality of light emitting devices, and the processor is further configured to:
determine a first color sequence of the light emitting devices at a first time point, wherein the first color sequence is obtained by arranging color values corresponding to the light emitting devices according to distances of the light emitting devices relative to the reference device at the first time point; and
determine a second color sequence of the light emitting devices at a second time point, wherein the second color sequence is obtained by arranging color values corresponding to the light emitting devices according to distances of the light emitting devices relative to the reference device at the second time point, wherein the second color sequence is a variation of the first color sequence based on cyclic arrangement.

11. The main control apparatus according to claim 1, wherein the processor is further configured to:
control the at least one light element of the at least one light emitting device based on new relative positions of the reference device and the at least one light emitting device, wherein the new relative positions of the reference device and the at least one light emitting device are different from the relative positions of the reference device and the at least one light emitting device.

12. The main control apparatus according to claim 11, wherein the at least one light emitting device comprises a fourth device, the fourth device is separated from the reference device at a farthest distance, and the processor is further configured to:
change a range of the virtual space based on new relative positions of the reference device and the fourth device;
determine relative positions of the at least one light emitting device and the reference device in a changed virtual space based on the new relative positions of the reference device and the at least one light emitting device;
determine a color distribution of the changed virtual space;
determine a color of the at least one light emitting device in a changed color distribution based on the relative position of the at least one light emitting device in the changed virtual space; and
determine a light color of the at least one light element based on the color of the at least one light emitting device in the changed color distribution.

13. The main control apparatus according to claim 12, wherein the processor is further configured to:
in response to a position change of the reference device, set a color value lower limit of the changed color distribution to be the same as a color value lower limit of the color distribution.

14. The main control apparatus according to claim 12, wherein the processor is further configured to:
in response to a position change of the reference device, determine a color value lower limit of the changed color distribution based on a new position of the reference device, so that the color value lower limit of the changed color distribution is different from a color value lower limit of the color distribution.

15. The main control apparatus according to claim 1, further comprising:
an input device configured to receive at least one user command, wherein the at least one user command indicates a distance upper limit, a color value upper limit, and a color value lower limit, and the processor is further configured to:
determine a diffusion area based on the distance upper limit and a diffusion effect parameter, wherein the diffusion effect parameter defines a variation of the diffusion area over time;
determine a color distribution of the diffusion area based on the color value upper limit and the color value lower limit; and
determine a light color of the at least one light element based on a color of the at least one light emitting device in the color distribution.

16. A lighting linkage method, comprising:
measuring relative positions of a reference device and at least one light emitting device via a wireless signal, wherein the reference device and the at least one light emitting device are connected using a communication protocol corresponding to the wireless signal, and each of the at least one light emitting device comprises at least one light element; and
controlling the at least one light element of the at least one light emitting device based on the relative positions of the reference device and the at least one light emitting device.

17. The lighting linkage method according to claim 16, wherein the at least one light emitting device comprises a first device, the wireless signal is a return signal transmitted from the first device to the reference device, and measuring the relative positions of the reference device and the at least one light emitting device via the wireless signal comprises:
transmitting a ranging signal;
receiving the return signal, wherein the return signal is used to feed back the ranging signal;
determining a return time of the return signal; and
determining a distance between the reference device and the first device based on at least one of the return time, a signal strength, and a phase shift of the return signal; and
determining an angle of the first device relative to the reference device based on an arrival angle of the return signal.

18. The lighting linkage method according to claim 16, wherein the at least one light emitting device comprises a second device, the second device is separated from the reference device at a farthest distance, and controlling the at least one light element of the at least one light emitting device based on the relative positions of the reference device and the at least one light emitting device comprises:
determining a range of a virtual space based on relative positions of the reference device and the second device, wherein the reference device is located at a center of the virtual space;
determining relative positions of the at least one light emitting device and the reference device in the virtual space based on the relative positions of the reference device and the at least one light emitting device;
determining a color distribution of the virtual space;
determining a color of the at least one light emitting device in the color distribution based on the relative position of the at least one light emitting device in the virtual space; and
determining a light color of the at least one light element based on the color of the at least one light emitting device in the color distribution.

19. The lighting linkage method according to claim 18, wherein determining the color distribution of the virtual space comprises:
corresponding a color of the second device to a color value upper limit of the color distribution; and
corresponding a color of the reference device to a color value lower limit of the color distribution.

20. The lighting linkage method according to claim 18, wherein determining the light color of the at least one light element based on the color of the at least one light emitting device in the color distribution comprises:
determining a conversion function of the color distribution, wherein
in the conversion function, a color value of the color distribution gradually varies from a color value at the center to a color value upper limit; and
obtaining the color of the at least one light emitting device in the color distribution by inputting the information about the relative positions of the reference device and the at least one light emitting device to the conversion function.

21. The lighting linkage method according to claim 18, wherein determining the light color of the at least one light element based on the color of the at least one light emitting device in the color distribution comprises:
determining a conversion function of the color distribution, wherein
in the conversion function, a color value of the color distribution gradually varies from a color value at a first point of the virtual space to a color value at a second point of the virtual space; and
obtaining the color of the at least one light emitting device in the color distribution by inputting the information about the relative positions of the reference device and the at least one light emitting device to the conversion function.

22. The lighting linkage method according to claim 18, wherein the at least one light emitting device comprises a third device, and the lighting linkage method further comprises:
transmitting a lighting indication signal, wherein the lighting indication signal comprises a color value of a color corresponding to the third device.

23. The lighting linkage method according to claim 18, wherein the at least one light emitting device comprises a plurality of light emitting devices, and determining the light color of the at least one light element based on the color of the at least one light emitting device in the color distribution comprises:
determining a first color sequence of the light emitting devices at a first time point, wherein the first color sequence is obtained by arranging color values corresponding to the light emitting devices according to distances of the light emitting devices relative to the reference device at the first time point; and
determining a second color sequence of the light emitting devices at a second time point, wherein the second color sequence is obtained by arranging color values corresponding to the light emitting devices according to distances of the light emitting devices relative to the reference device at the second time point, wherein the second color sequence is a variation of the first color sequence based on cyclic arrangement.

24. The lighting linkage method according to claim 18, further comprising:
controlling the at least one light element of the at least one light emitting device based on new relative positions of the reference device and the at least one light emitting device, wherein the new relative positions of the reference device and the at least one light emitting device are different from the relative positions of the reference device and the at least one light emitting device.

25. The lighting linkage method according to claim 24, wherein the at least one light emitting device comprises a fourth device, the fourth device is separated from the reference device at a farthest distance, and controlling the at least one light element of the at least one light emitting device based on the new relative positions of the reference device and the at least one light emitting device comprises:
changing a range of the virtual space based on new relative positions of the reference device and the fourth device;
determining relative positions of the at least one light emitting device and the reference device in a changed virtual space based on the new relative positions of the reference device and the at least one light emitting device;
determining a color distribution of the changed virtual space;
determining a color of the at least one light emitting device in a changed color distribution based on the relative position of the at least one light emitting device in the changed virtual space; and
determining the light color of the at least one light element based on the color of the at least one light emitting device in the changed color distribution.

26. The lighting linkage method according to claim 25, wherein determining the color distribution of the changed virtual space comprises:
in response to a position change of the reference device, setting a color value lower limit of the changed color distribution to be the same as a color value lower limit of the color distribution.

27. The lighting linkage method according to claim 25, wherein determining the color distribution of the changed virtual space comprises:
in response to a position change of the reference device, determining a color value lower limit of the changed color distribution based on a new position of the reference device, so that the color value lower limit of the changed color distribution is different from a color value lower limit of the color distribution.

28. The lighting linkage method according to claim 16, wherein controlling the at least one light element of the at least one light emitting device based on the relative positions of the reference device and the at least one light emitting device comprises:
receiving at least one user command, wherein the at least one user command indicates a distance upper limit, a color value upper limit, and a color value lower limit;
determining a diffusion area based on the distance upper limit and a diffusion effect parameter, wherein the diffusion effect parameter defines a variation of the diffusion area over time;
determining a color distribution of the diffusion area based on the color value upper limit and the color value lower limit; and
determining the light color of the at least one light element based on a color of the at least one light emitting device in the color distribution.

29. A lighting control system, comprising:
the main control apparatus according to claim 1; and
at least one light emitting device wirelessly connected to the main control apparatus.
